(19) United States
(12) Patent Application Publication
(10) Pub. No.: US 2025/0108762 A1
(43) Pub. Date: Apr. 3, 2025

(54) STEP DEVICE AND VEHICLE

(71) Applicant: T-MAX (HANGZHOU) TECHNOLOGY CO., LTD., Hangzhou (CN)

(72) Inventors: Xinfa DU, Hangzhou (CN); Qi ZHANG, Hangzhou (CN); Linjie XU, Hangzhou (CN); Guixiang YIN, Hangzhou (CN); Yiming WANG, Hangzhou (CN); Xing FAN, Hangzhou (CN)

(21) Appl. No.: 18/602,842

(22) Filed: Mar. 12, 2024

(30) Foreign Application Priority Data
Sep. 28, 2023 (CN) 2023112855391
Sep. 28, 2023 (CN) 2023226638352
Sep. 28, 2023 (CN) 2023226814602

(51) Int. Cl. B60R 3/02

(52) U.S. Cl. CPC B60R 3/02

(57) ABSTRACT

Disclosed are a vehicle step device and a vehicle comprising the vehicle step device. In some embodiments, the vehicle step device includes a mounting frame; a fixed step mounted on the mounting frame; a retractable mechanism mounted to one of the mounting frame and the fixed step; and a retractable step mounted on the retractable mechanism so that the retractable mechanism is configured to drive the retractable step to move between an extended position and a retracted position. In the extended position, at least a part of the retractable step extends outward beyond the fixed step from underneath the fixed step so that the retractable step and the fixed step form two steps, and in the retracted position, the retractable step retracts to a position underneath the fixed step.

### CROSS-REFERENCE TO RELATED APPLICATIONS

This application is based on and claims priority to and benefits of Chinese Patent Applications No. 202311285539.1, 202322663835.2 and 202322681460.2, filed on Sep. 28, 2023. The entire contents of the aforementioned patent documents are incorporated by reference for all purposes.

### TECHNICAL FIELD

The present disclosure relates to the field of vehicles, and specifically relate to a step device and a vehicle having the same.

### BACKGROUND

It is inconvenient for people to enter and exit vehicles with large ground clearances, such as off-road vehicles and buses. Therefore, steps are usually mounted on the vehicles to facilitate people to step thereon so as to enter and exit the vehicles. However, the traditional step still has the problem of poor practical convenience. For example, for vehicles with large ground clearances, the height of the traditional step is too low or too high, which affects the convenience of use and applicability to different vehicles.

### SUMMARY

In some aspects, a step device for a vehicle according to some embodiments of a first aspect of the present technology includes a mounting frame; a fixed step mounted on the mounting frame; a retractable mechanism mounted to one of the mounting frame and the fixed step; and a retractable step mounted on the retractable mechanism so that the retractable mechanism drives the retractable step to move between an extended position and a retracted position. In the extended position, at least a part of the retractable step extends outward beyond the fixed step from underneath the fixed step so that the retractable step and the fixed step form two steps; and, in the retracted position, the retractable step retracts to a position underneath the fixed step.

The step device for a vehicle according to some embodiments of the present technology has the advantages having a compact structure, providing an improved convenience for a user to embark and disembark to/from a high-clearance vehicle using the step device, a low level of difficulty to mount and detach from the vehicle (e.g., installation), and a high level of efficiency when mounting and detaching, and being highly applicable to a wide variety of vehicles, particularly those with large ground clearance heights (e.g., ground to floor of vehicle interior).

In some aspects, a vehicle according to some embodiments of a second aspect of the disclosed technology includes a vehicle body, a vehicle door, and a step device of the present technology. In some embodiments of the step device, the mounting frame of the step device can be mounted on the vehicle body.

The vehicle according to the embodiments of the present disclosure has the advantages of a low assembly and disassembly difficulty and a high assembly and disassembly efficiency.

### BRIEF DESCRIPTION OF THE DRAWINGS

FIG. 1 is a partial exploded view of a step device according to some embodiments of the present technology.

FIG. 2 is a partial exploded view of a vehicle according to some embodiments of the present technology.

FIG. 3 is a schematic view of a mounting frame of a step device according to some embodiments of the present technology.

FIG. 4 is a partial schematic view of a vehicle according to some embodiments of the present technology, in which a retractable step is in a retracted position.

FIG. 5 is a partial schematic view of a vehicle according to some embodiments of the present technology, in which a retractable step is in an extended position.

FIG. 6 is a partial exploded view of a vehicle according to some embodiments of the present technology.

FIG. 7 is a partial exploded view of a vehicle according to some embodiments of the present technology.

FIG. 8 is a partial exploded view of a step device according to some embodiments of the present technology.

FIG. 9 is a partial exploded view of a step device according to some embodiments of the present technology.

FIG. 10 is a partial exploded view of a step device according to some embodiments of the present technology.

FIG. 11 is a partial exploded view of a step device according to some embodiments of the present technology.

FIG. 12 is a partial schematic view of a vehicle according to some embodiments of the present technology.

FIG. 13 is a partial schematic view of a vehicle according to some embodiments of the present technology.

FIG. 14 is an exploded view of a retractable mechanism of a step device according to some embodiments of the present technology.

FIG. 15 is an exploded view of a retractable mechanism of a step device according to some embodiments of the present technology.

FIG. 16 is an exploded view of a retractable mechanism of a step device according to some embodiments of the present technology.

FIG. 17 is a schematic view of a vehicle according to some embodiments of the present technology, in which a retractable step is in a retracted position.

FIG. 18 is a schematic view of a vehicle according to some embodiments of the present technology, in which a retractable step is in an extended position.

FIG. 19 is a partial schematic view of a step device according to some embodiments of the present technology, in which a retractable step is in an extended position.

FIG. 20 is a partial exploded view of a step device according to some embodiments of the present technology.

FIG. 21 is a partial exploded view of a step device according to some embodiments of the present technology.

FIG. 22 is a partial exploded view of a step device according to some embodiments of the present technology.

FIG. 23 is a schematic view of a mounting bracket of a vehicle body of a vehicle according to some embodiments of the present technology.

FIG. 24 is a partial schematic view of a step device according to some embodiments of the present technology.

FIG. 25 is a partial schematic view of a step device according to some embodiments of the present technology.

FIG. 26 is a schematic diagram of a step device according to some embodiments of the present technology.

FIG. 27 is a schematic diagram of a step device according to some embodiments of the present technology.

FIG. 28 is a schematic diagram of a step device according to some embodiments of the present technology.

FIG. 29 is a schematic diagram of a step device according to some embodiments of the present technology.

FIG. 30 is a schematic view of a vehicle according to some embodiments of the present technology, in which a retractable step is in a retracted position.

### DETAILED DESCRIPTION

Hereinafter, embodiments of the present disclosure will be described in detail, and examples of the embodiments are illustrated in the accompanying drawings. The embodiments described below by referring to the accompanying drawings are illustrative and are intended to explain the present disclosure, and should not be construed as limiting the present disclosure.

For convenience of description, in the description of the embodiments of the present disclosure, a front-rear direction refers to a front-rear direction of a vehicle after a step is mounted on a vehicle body. After the step is mounted on the vehicle body, a direction toward the inside of the vehicle body is inward and a direction toward the outside of the vehicle body is outward.

Presently, for existing vehicle step devices, the step device that is mounted on the vehicle is usually fixed, and the height of the fixed step from the ground is fixed, so that the applicability and convenience are poor. Moreover, for conventional vehicle step devices, it is typically required to install a retractable step on the vehicle. When in use, the retractable step extends from underneath the vehicle, and when not in use, the retractable step retracts to a position underneath the vehicle.

However, for a vehicle with a large ground clearance (between the ground and the floor of the vehicle), the fixed step and the retractable step may have the problems of high height and inconvenience of use, particularly for shorter individuals, elderly, and/or children to embark and disembark from the vehicle. Therefore, it is proposed to provide a vehicle step apparatus with a fixed step and the retractable step to be mounted on the vehicle, so that the retractable step forms a second step with the fixed step for the vehicle step apparatus when extended outward, thus improving the convenience and safety of use and the applicability for different vehicles.

However, for existing vehicle step devices in the related art, either a fixed step and a retractable step is mounted under the vehicle, lacking ability to accommodate high ground clearance and/or different heights and stepping abilities of various users to easily and conveniently get in and out of the vehicle. Moreover, having the fixed step and the retractable step respectively mounted under the vehicle, leads to a complicated mounting structure and a time-consuming and laborious assembly (and disassembly) for installation and/or repair. Moreover, due to the limited space under a chassis of the vehicle, both mounting difficulties and operation difficulties of the fixed step and the retractable step are further increased. In addition, in such conventional vehicle step devices, the retractable step is located completely under the vehicle in a retracted position, which will adversely affect the trafficability of the vehicle.

In addition, in the related art, the number of the retractable steps mounted on the vehicle is determined in advance, and a control system for the retractable steps has a number of interfaces equal to the number of the retractable steps. When the user wants to increase the number of the retractable steps (for example, when a user wants to add the retractable step at the tailgate of the vehicle), the whole control system needs to be replaced, resulting in a high cost, an inconvenient refitting, and a poor user experience.

The present technology solves at least some of the above technical problems to some extent.

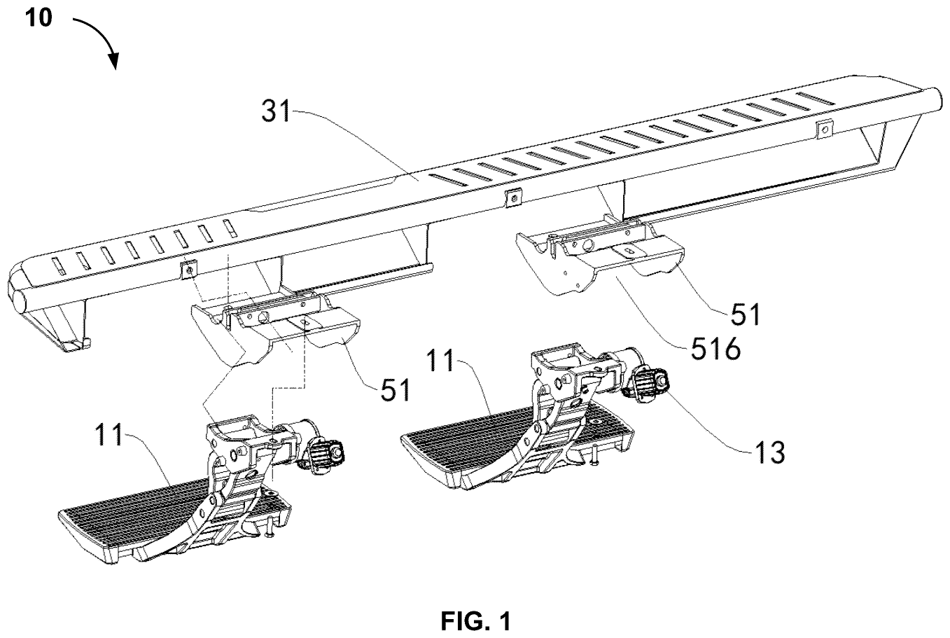

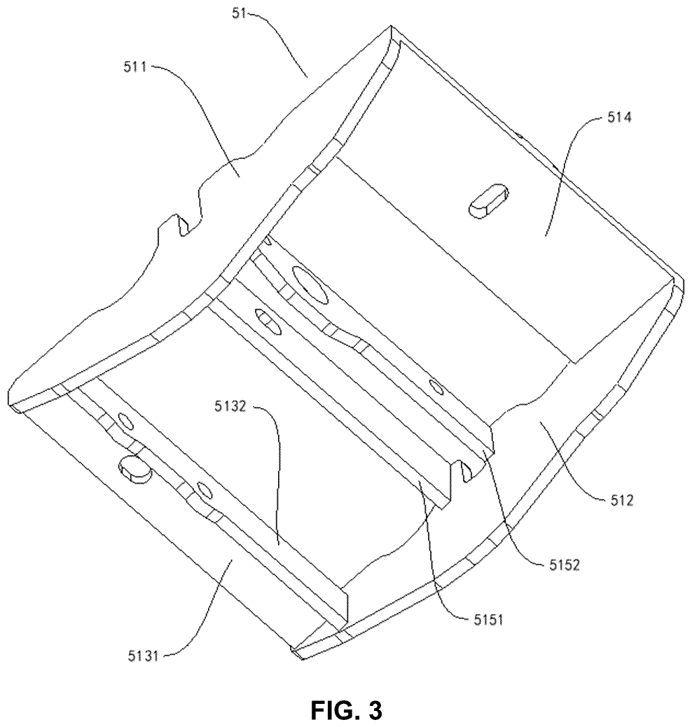

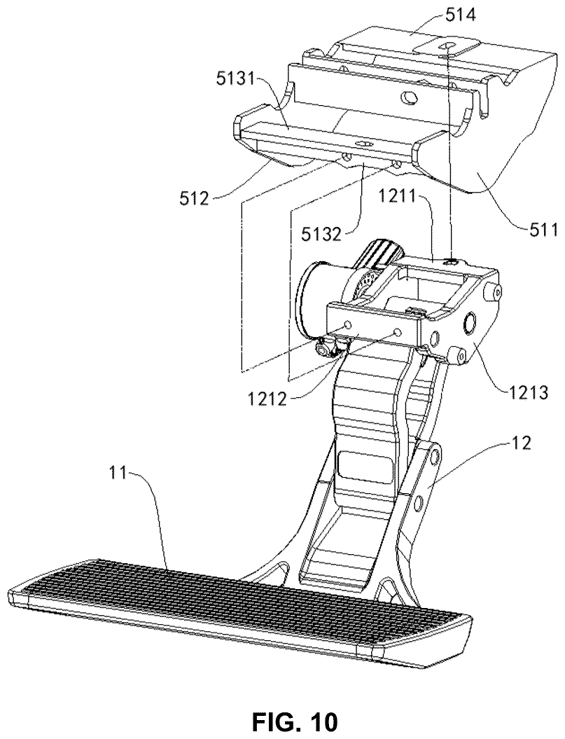

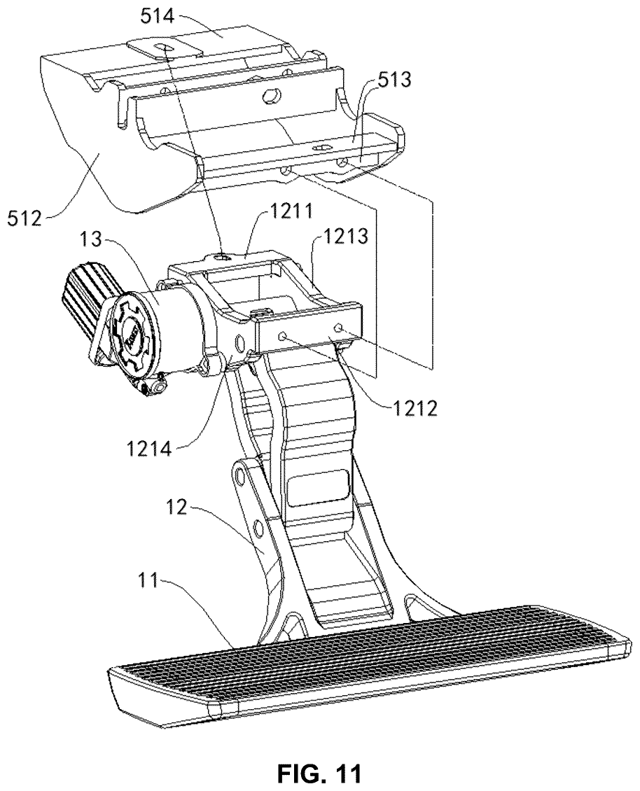

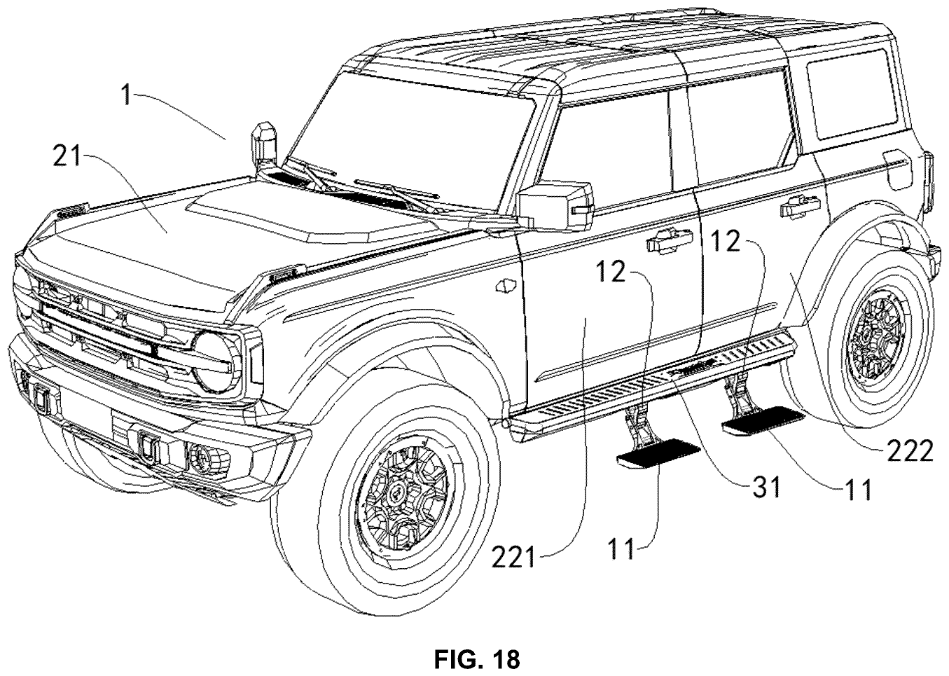

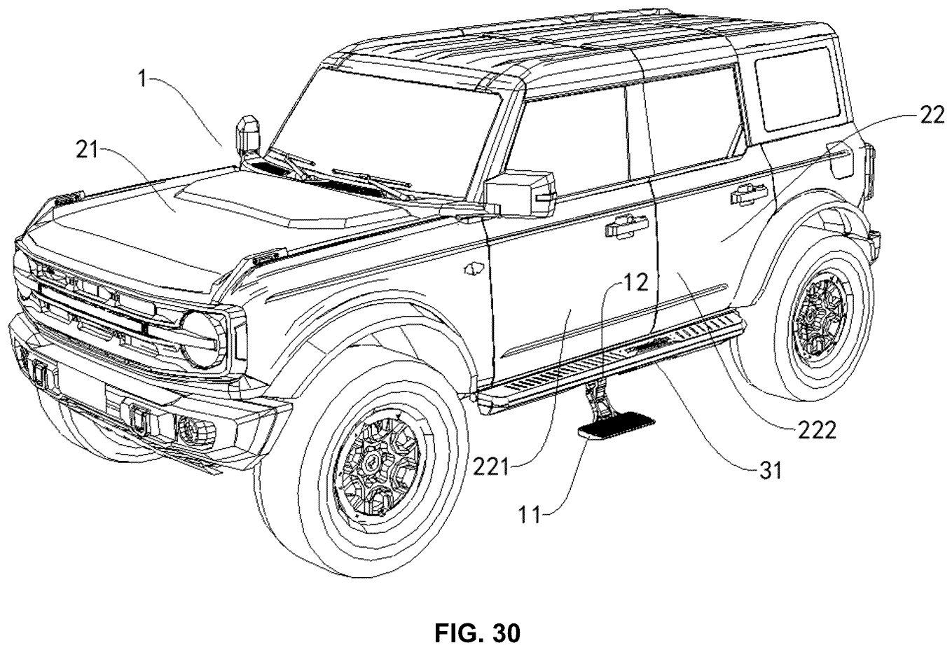

As shown in FIGS. 1-30, a step device 10, in accordance with some of the embodiments of the present technology, includes a mounting frame 51, a fixed step 31, a retractable mechanism 12, and a retractable step 11. The fixed step 31 is mounted on the mounting frame 51.

The retractable mechanism 12 is mounted on one of the mounting frame 51 and the fixed step 31, and the retractable step 11 is mounted on the retractable mechanism 12 so that the retractable mechanism 12 drives the retractable step 11 to move between an extended position and a retracted position. At the extended position, at least a part of the retractable step 11 extends outward beyond the fixed step 31 from underneath the fixed step 31, so that the retractable step 11 and the fixed step 31 form two steps. In the retracted position, the retractable step 11 is retracted to a position underneath the fixed step 31.

According to some embodiments of the step device 10, by mounting both the fixed step 31 and the retractable mechanism 12 on the mounting frame 51 or by mounting the retractable mechanism 12 on the fixed step 31 and mounting the fixed step 31 on the mounting frame 51, the step device 10 can be assembled into a whole, so that the step device 10 can be mounted or detached simply by mounting the mounting frame 51 to a vehicle body 21 or detaching the mounting frame 51 from the vehicle body 21.

That is, before mounting the step device 10 to the vehicle body 21 of the vehicle 1, the fixed step 31, the retractable step 11, the retractable mechanism 12 and the mounting frame 51 can be assembled together. Therefore, it is possible to reduce the difficulties of mounting the step device 10 to the vehicle body 21 and detaching the step device 10 from the vehicle body 21, thus improving the efficiency of mounting the step device 10 to the vehicle body 21 and detaching the step device 10 from the vehicle body 21.

Moreover, by retracting the whole or at least most of the retractable step 11 to be below the fixed step 31 without retracting it to be below the vehicle body 21 or at least without retracting the whole retractable step 11 to be below the vehicle body 21, the space between the chassis of the vehicle 1 and the ground will not be significantly occupied, so that the distance between the chassis of the vehicle 1 and the ground is ensured, thereby ensuring the trafficability of the vehicle 1. In the extended position, the fixed step and the retractable step form multi-stage steps, which is especially beneficial for a vehicle with high ground clearance, thus providing a good applicability and a wide application range.

Therefore, the step device 10 of the embodiments of the present disclosure has the advantages of a compact structure, a low mounting and detaching difficulty, a high mounting and detaching efficiency, and the like.

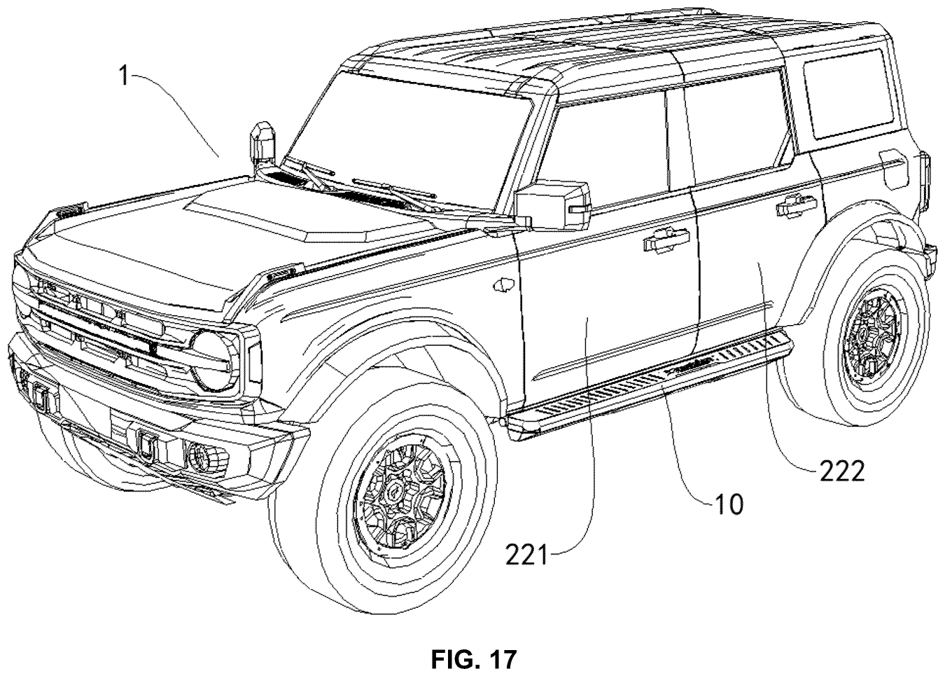

As shown in FIGS. 1-30, according to some of the embodiments of the present technology, a vehicle 1 includes a vehicle body 21, a vehicle door, and an example embodiment of the step device 10 in accordance with the present technology. As shown in FIG. 17, the vehicle door includes a left front door 221, a left rear door 222, a right front door (not shown), a right rear door (not shown) and a tailgate (not shown). The driver can enter and leave the cab through the left front door 221, and the driver can also enter and leave the cab through the right front door. The mounting frame 51 of the step device 10 is mounted to the vehicle body 21.

The step device 10 includes a mounting frame 51, a fixed step 31, a retractable step 11, and a retractable mechanism 12. The mounting frame 51 may be mounted to the vehicle body 21.

As shown in FIGS. 1-3 and 6-11, the mounting frame 51 includes a first side plate 511, a second side plate 512, an outer beam 513, an inner beam 514 and a middle beam 515. The first side plate 511 and the second side plate 512 are spaced apart from each other along a length direction of the fixed step 31, that is, the first side plate 511 and the second side plate 512 are spaced apart from each other along a length direction of the vehicle body 21.

A first end of the outer beam 513 is connected with the first side plate 511, a second end of the outer beam 513 is connected with the second side plate 512, a first end of the inner beam 514 is connected with the first side plate 511, a second end of the inner beam 514 is connected with the second side plate 512, a first end of the middle beam 515 is connected with the first side plate 511, and a second end of the middle beam 515 is connected with the second side plate 512. That is, the first side plate 511 and the second side plate 512 are connected together by each of the outer beam 513, the inner beam 514 and the middle beam 515.

The inner beam 514 is located on an inner side of the outer beam 513, and the middle beam 515 is located between the inner beam 514 and the outer beam 513. The fixed step 31 is connected with the outer beam 513 and the middle beam 515 through a connector, and the retractable mechanism 12 is connected with the inner beam 514 and the outer beam 513 through a connector. Thus, the fixed step 31 and the retractable mechanism 12 can be more stably mounted on the mounting frame 51.

The inner beam 514 is an inner transverse plate lying horizontally. That is, the inner beam 514 is generally plate-shaped, and the inner beam 514 is horizontally arranged, i.e., a thickness direction of the inner beam 514 is consistent with an up-down direction.

The outer beam 513 includes a first outer transverse plate 5131 lying horizontally and a second outer transverse plate 5132 standing vertically. In other words, each of the first outer transverse plate 5131 and the second outer transverse plate 5132 is generally plate-shaped, the first outer transverse plate 5131 is horizontally arranged, i.e., a thickness direction of the first outer transverse plate 5131 is consistent with the up-down direction, and the second outer transverse plate 5132 is vertically arranged, i.e., the thickness direction of the second outer transverse plate 5132 is consistent with a horizontal direction. An upper edge of the second outer transverse plate 5132 is connected with the first outer transverse plate 5131.

The middle beam 515 includes a first middle transverse plate 5151 standing vertically and a second middle transverse plate 5152 standing vertically. That is, each of the first middle transverse plate 5151 and the second middle transverse plate 5152 is generally plate-shaped, and both of them are vertically arranged, i.e., a thickness direction of the first middle transverse plate 5151 is consistent with the horizontal direction, and a thickness direction of the second middle transverse plate 5152 is consistent with the horizontal direction. The first middle transverse plate 5151 and the second middle transverse plate 5152 are arranged at intervals in an inner-outer direction.

The fixed step 31 is connected with the first outer transverse plate 5131 and the first middle transverse plate 5151, and the retractable mechanism 12 is connected with the inner transverse plate (the inner beam 514) and the second outer transverse plate 5132. The lower surface of the inner transverse plate is higher than the upper surface of the first outer transverse plate 5131. The connection position between the fixed step 31 and the first middle transverse plate 5151 and the second middle transverse plate is higher than the upper surface of the first outer transverse plate 5131. Therefore, the structures of the mounting frame 51 and the step device 10 can be more easily made.

As shown in FIGS. 1-3 and 6-11, a mounting support seat 121 of the retractable mechanism 12 includes a first horizontal plate 1211, a first vertical plate 1212, a third side plate 1213 and a fourth side plate 1214. The third side plate 1213 and the fourth side plate 1214 are spaced apart from each other along a length direction of the fixed step 31, that is, the third side plate 1213 and the fourth side plate 1214 are spaced apart from each other along the length direction of the vehicle body 21.

A first end of the first horizontal plate 1211 is connected with the third side plate 1213, a second end of the first horizontal plate 1211 is connected with the fourth side plate 1214, a first end of the first vertical plate 1212 is connected with the third side plate 1213, and a second end of the first vertical plate 1212 is connected with the fourth side plate 1214. That is, the third side plate 1213 and the fourth side plate 1214 are connected together by each of the first horizontal plate 1211 and the first vertical plate 1212.

The first horizontal plate 1211 and the inner beam 514 are connected by a bolt. Specifically, the first horizontal plate 1211 has a first through hole, and the inner beam 514 has a second through hole, and the bolt passes through the first through hole and the second through hole to connect the first horizontal plate 1211 with the inner beam 514.

The first vertical plate 1212 and the second outer transverse plate 5132 are connected by a bolt. Specifically, the first vertical plate 1212 has two third through holes, and the second outer transverse plate 5132 has two fourth through holes. One bolt passes through one of the third through holes and one of the fourth through holes to connect the first vertical plate 1212 with the second outer transverse plate 5132, and the other bolt passes through the other third through hole and the other fourth through hole to connect the first vertical plate 1212 with the second outer transverse plate 5132.

In some embodiments, the distance between the one of the third through holes and the third side plate 1213 in the length direction of the fixed step 31 is approximately equal to the distance between the other third through hole and the fourth side plate 1214 in the length direction of the fixed step 31. For example, the third side plate 1213 and the fourth side plate 1214 are symmetrically arranged with respect to a first straight line (a first vertical plane), and the two third through holes are also symmetrically arranged with respect to the first straight line (the first vertical plane).

One of the fourth through holes is adjacent to the first side plate 511 in the length direction of the fixed step 31, and the distance between the other fourth through hole and the first side plate 511 in the length direction of the fixed step 31 is approximately equal to the distance between the other fourth through hole and the second side plate 512 in the length direction of the fixed step 31. That is, the other fourth through hole is located in the middle of the first side plate 511 and the second side plate 512.

As shown in FIGS. 1-2 and 12-13, the retractable mechanism 12 includes a mounting support seat or bracket 121, a step support seat or bracket 122, and an arm assembly connected between the mounting support seat 121 and the step support seat 122. The mounting frame 51 has a mounting groove 516, and at least a part of the mounting support seat 121 is accommodated in the mounting groove 516. Therefore, the structure of the step device 10 can be made more compact.

As shown in FIGS. 1-2, 8-9 and 12-13, the fixed step 31 includes a frame 313, a support plate 314 and a plate bracket 315. The frame 313 includes an inner tube 3131, an outer tube 3132, an end tube 3133 and a reinforcing tube 3134. The support plate 314 is mounted on the frame 313, and the plate bracket 315 is mounted under the frame 313. The reinforcing tube 3134 is connected between the inner tube 3131 and the outer tube 3132.

A length direction of the inner tube 3131 coincides with the length direction of the vehicle body 21, and a length direction of the outer tube 3132 coincides with the length direction of the vehicle body 21. There are a plurality of reinforcing tubes 3134, which are arranged at intervals along the length direction of the inner tube 3131 (the outer tube 3132). An inner end of each reinforcing tube 3134 is connected with the inner tube 3131, and an outer end of each reinforcing tube 3134 is connected with the outer tube 3132.

The inner tube 3131 has a fifth through hole, and the first middle transverse plate 5151 has a sixth through hole, and a bolt passes through the fifth through hole and the sixth through hole to connect the inner tube 3131 and the first middle transverse plate 5151. The second middle transverse plate 5152 has a through hole opposite the sixth through hole so that the bolt passes through the second middle transverse plate 5152. The reinforcing tube 3134 has a seventh through hole, and the first outer transverse plate 5131 has an eighth through hole, and a bolt passes through the seventh through hole and the eighth through hole to connect the reinforcing tube 3134 with the first outer transverse plate 5131.

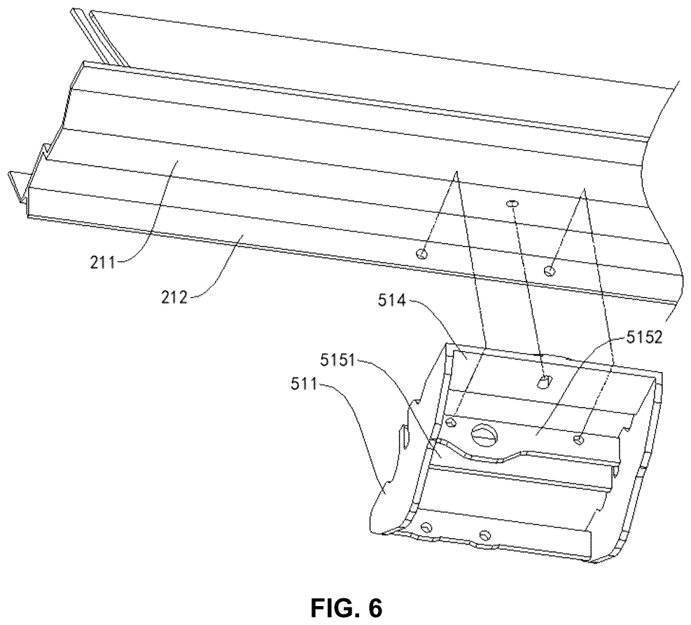

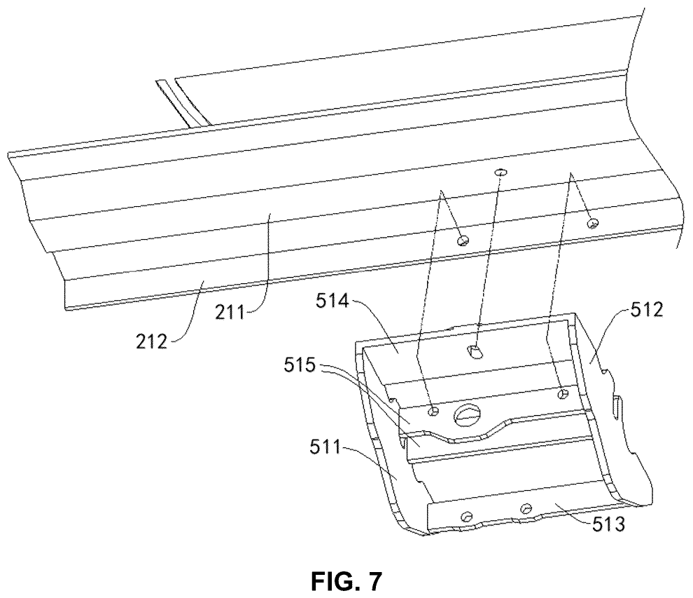

As shown in FIGS. 6 and 7, the vehicle body 21 includes a second horizontal plate 211 and a second vertical plate 212. The inner beam 514 of the mounting frame 51 is connected to the second horizontal plate 211. In some embodiments, the second horizontal plate 211, the inner beam 514 and the first horizontal plate 1211 are connected by the same connector. The second vertical plate 212 is connected with the second middle transverse plate 5152. Thus, the mounting frame 51 can be more stably mounted on the vehicle body 21.

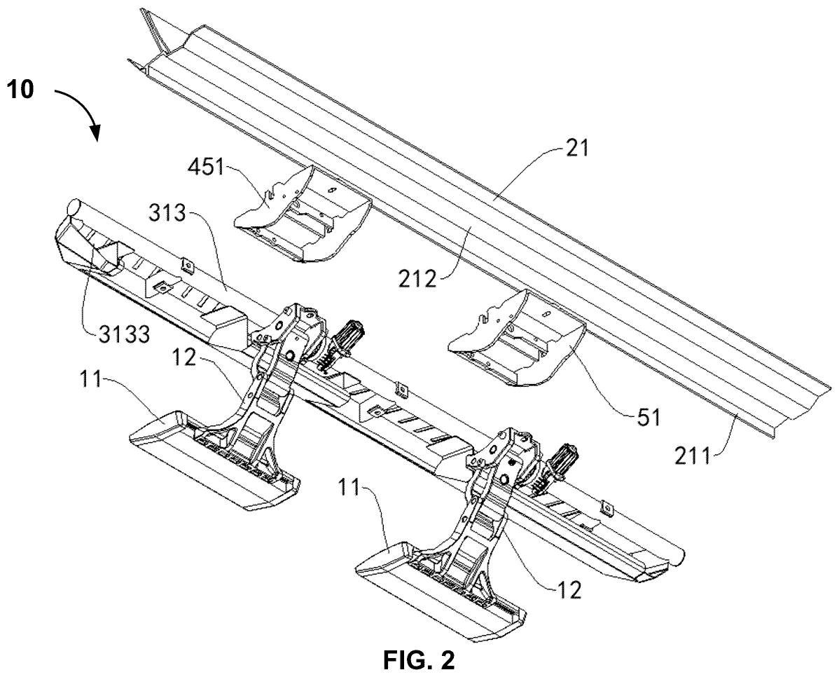

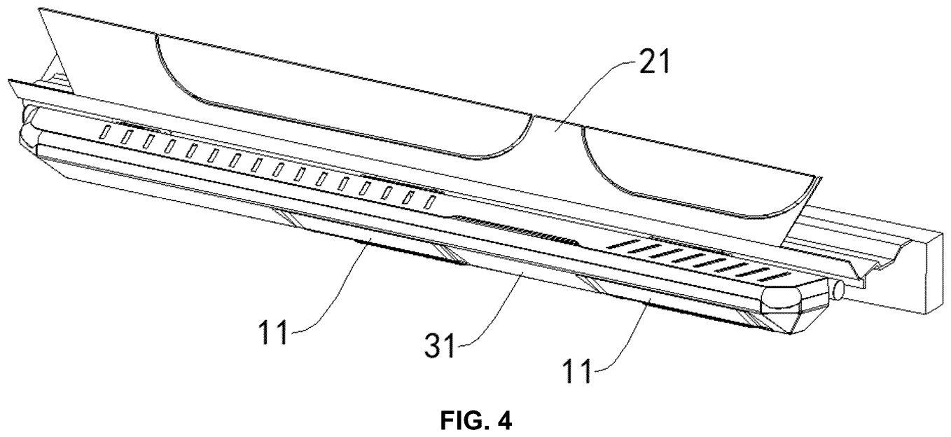

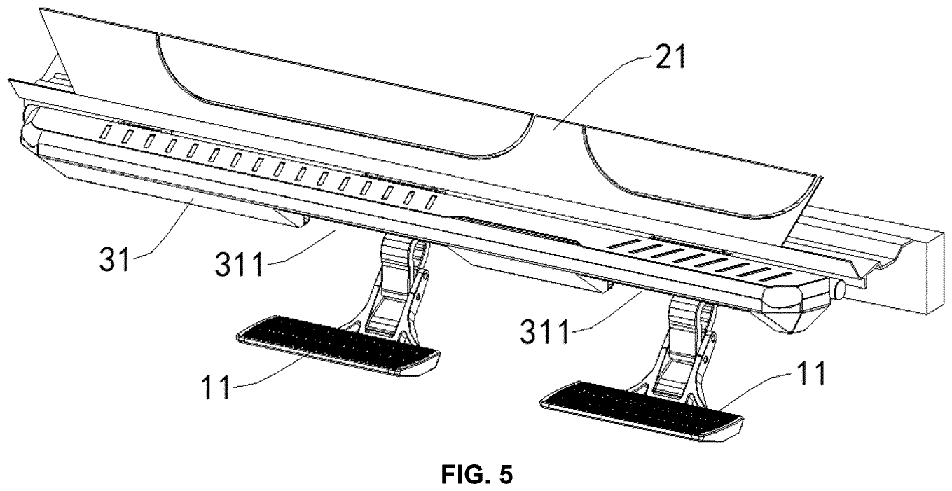

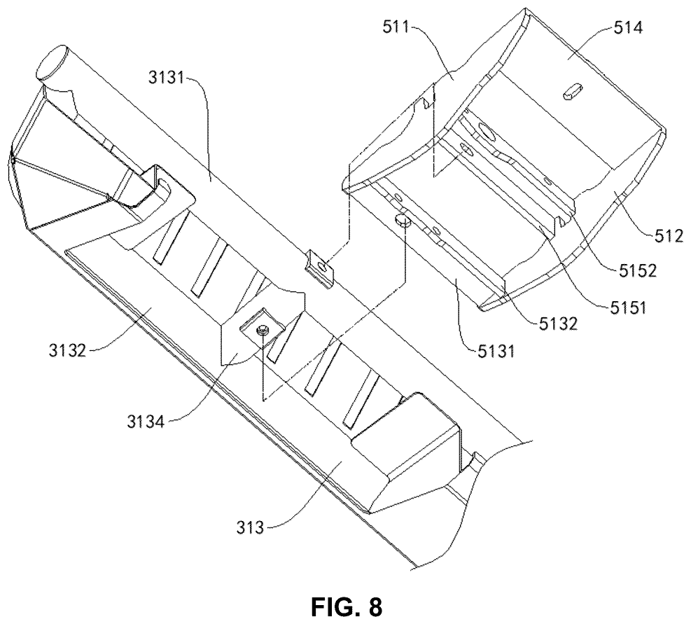

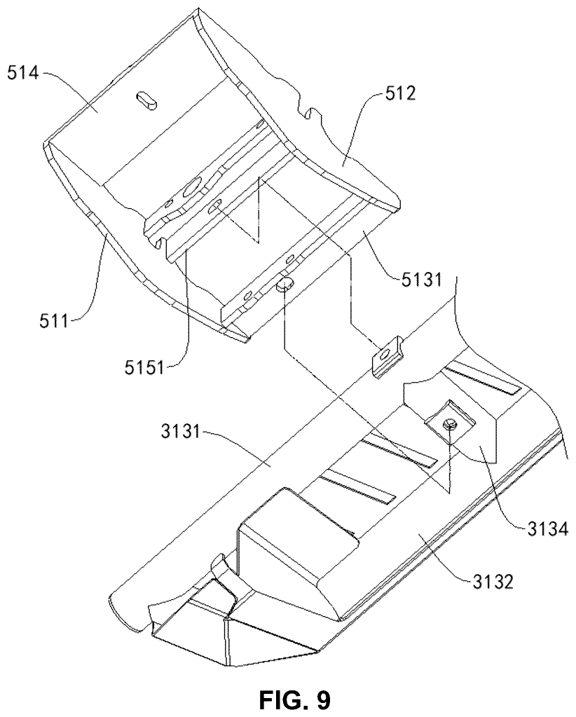

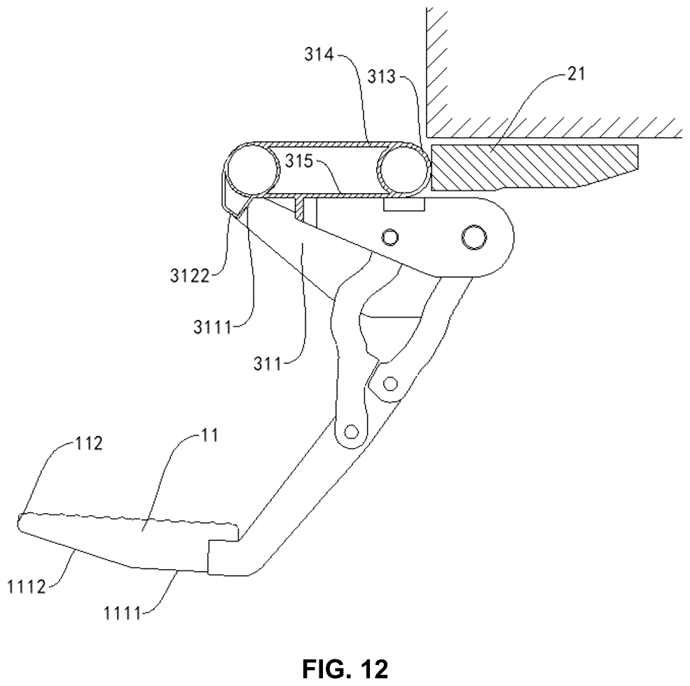

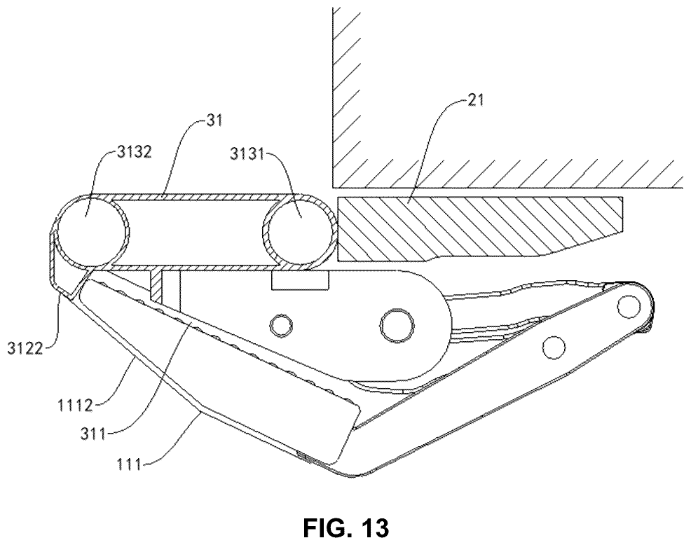

As shown in FIG. 1, FIG. 2, FIG. 4, FIG. 5, FIG. 8, FIG. 9, FIG. 12, and/or FIG. 13, the fixed step 31 has an accommodating groove 311, the mounting frame 51 is mounted at the accommodating groove 311, and the retractable mechanism 12 is mounted at the accommodating groove 311. In the retracted position, the whole retractable step 11 or a part of the retractable step 11 is accommodated in the accommodating groove 311. Therefore, the accommodating groove 311 of the fixed step 31 can be used to protect the retractable step 11, so as to prevent foreign matter such as sand and gravel from entering a gap between the retractable step 11 and the fixed step 31 and prevent the retractable step 11 from being damaged by the external foreign matter such as sand and gravel, thereby prolonging the service life of the retractable step 11 and the step device 10. Furthermore, the structure of the step device 10 can be made more compact.

In some embodiments, in the retracted position, at least a part of the surface of the retractable step 11 is flush with the surface of the fixed step 31. Therefore, the accommodating groove 311 can better protect the retractable step 11, further prolonging the service life of the retractable step 11 and the step device 10 and making the structure of the step device 10 more compact.

A bottom surface of the fixed step 31 includes a first inclined surface portion 3122 that is inclined downward from outside to inside, and a bottom surface 111 of the retractable step 11 includes a first flat surface portion 1111 that is horizontal at the extended position and a second inclined surface portion 1112 that is inclined downward from outside to inside. In other words, the bottom surface 111 of the retractable step 11 includes the first flat surface portion 1111 and the second inclined surface portion 1112. The first flat surface portion 1111 of the retractable step 11 at the extended position is located on a horizontal plane, that is, the first flat surface portion 1111 of the retractable step 11 in the extended position is horizontally arranged, and the second inclined surface portion 1112 of the retractable step 11 in the extended position is obliquely arranged. When the retractable step 11 is in the extended position, an inner edge of the second inclined surface portion 1112 is connected with an outer edge of the first flat surface portion 1111, and the inner edge of the second inclined surface portion 1112 is located below an outer edge of the second inclined surface portion 1112.

In the retracted position, the second inclined surface portion 1112 is flush with the first inclined surface portion 3122, and an outer side surface 112 of the retractable step 11 is opposite an outer side wall surface 3111 of the accommodating groove 311. Therefore, the accommodating groove 311 can better protect the retractable step 11 and further prolong the service life of the retractable step 11 and the step device 10.

In some embodiments, in the retracted position, a gap between the outer side surface 112 of the retractable step 11 and the outer side wall surface 3111 of the accommodating groove 311 is greater than or equal to zero and less than or equal to 5 mm. Therefore, the external foreign matter such as sand and gravel can be further prevented from entering the accommodating groove 311, that is, the external foreign matter such as sand and gravel can be further prevented from entering to be between the fixed step 31 and the retractable step 11 located in the retracted position, so that the retractable step 11 can be better protected, and the service life of the retractable step 11 and the step device 10 can be further improved.

Each retractable step 11 is mounted on a corresponding retractable mechanism 12. The step device 10 further includes a motor 13, which is connected with the corresponding retractable mechanism 12, and the motor 13 is used for driving the corresponding retractable mechanism 12 to drive the corresponding retractable step 11 to move between the extended position and the retracted position.

In some embodiments, the motor 13 is a brushless motor. The brushless motor has the advantages of a small size, a simple control program, an accurate position and a speed control of the retractable step 11, and a small impact, and can stop the retractable step 11 at any position between the extended position and the retracted position.

In some embodiments, the whole of the fixed step 31 is located at an outer side of the vehicle body 21. Or, a distance between an innermost point of the fixed step 31 and an outer side surface of the vehicle body 21 is less than 20 mm, that is, the distance between the innermost point of the fixed step 31 and the outer side of the vehicle body 21 in the inner-outer direction is less than 20 mm. Therefore, the whole or most of the fixed step 31 can be located at the outer side of the vehicle body 21, so that it is convenient for the user to get on (enter) and get off (exit) the vehicle by stepping on the fixed step 31, and thus the user can enter and exit the vehicle more easily.

In some embodiments, in the retracted position, the whole of the retractable step 11 is located on the outer side of the vehicle body 21. Or, a distance between an innermost point of the retractable step 11 and the outer side surface of the vehicle body 21 is less than 30 mm, that is, the distance between the innermost point of the retractable step 11 and the outer side surface of the vehicle body 21 in the inner-outer direction is less than 30 mm. Therefore, when the retractable step 11 moves from the retracted position to the extended position, the retractable step 11 can be extended from the vehicle body 21 by a large distance, so that it is convenient for the user to enter and exit the vehicle by stepping on the retractable step 11, and thus the user can enter and exit the vehicle more easily.

In some example embodiments, the step device 10 further includes a controller 14 having a plurality of interfaces 141. The retractable step device includes at least one retractable step 11, and each retractable step 11 is mounted on a corresponding retractable mechanism 12. The motor 13 has a one-to-one correspondence with the retractable mechanism 12. Each motor 13 is connected with a corresponding retractable mechanism 12 to drive the corresponding retractable mechanism 12 to drive the corresponding retractable step 11 to move between the extended position and the retracted position. In other words, the motor 13 can drive the retractable step 11 mounted on the retractable mechanism 12 to extend and retract through the corresponding retractable mechanism 12. The number of the interfaces 141 is greater than that of the retractable steps 11, and one motor 13 driving one retractable mechanism 12 corresponding to each retractable step 11 is connected to one interface 141.

In some example embodiments, the step device 10 further includes a controller 14 having a plurality of interfaces 141. The retractable step device includes at least one retractable step 11, and each retractable step 11 is mounted on at least one of a plurality of corresponding retractable mechanisms 12. The motor 13 has a one-to-one correspondence with the retractable mechanism 12. Each motor 13 is connected with the corresponding retractable mechanism 12 to drive the corresponding retractable mechanism 12 to drive the corresponding retractable step 11 to move between the extended position and the retracted position. In other words, the motor 13 can drive the retractable step 11 mounted on the retractable mechanism 12 to extend and retract through the corresponding retractable mechanism 12. The number of the interfaces 141 is greater than that of the retractable steps 11, and a plurality of motors 13 driving a plurality of retractable mechanisms 12 corresponding to the same retractable step 11 are connected to the same interface 141.

According to some example embodiments of the step device of the present technology, a controller with the plurality of interfaces is arranged, and the number of the interfaces is greater than the number of the retractable steps, so that at least one retractable step can be controlled only by using only one controller. Therefore, the cost of the controller and the step device can be reduced, the diversity of mounting positions of the controller can be saved, the difficulty of installing and mounting the controller can be reduced, and the integration of the step device can be improved.

Since the number of the interfaces is greater than the number of the retractable steps, even if the user adds the retractable steps later, there is no need to arrange new controllers. That is to say, the controller has a reserved interface to connect the motor driving the additional retractable steps, thus enabling the user to change the number of the retractable steps as required. Moreover, when the step device is used in different vehicle models, the user can increase or decrease the number of the retractable steps according to the vehicle models, without additionally arranging new controllers or detaching the controllers already arranged.

In the present disclosure, “the number of the interfaces is greater than the number of the retractable steps” means that the number of the interfaces of the controller is greater than the number of the initial retractable steps of the step device, so that the redundant interfaces can be used as reserved interfaces, and thus the number of the retractable steps of the step device can be expanded. It can be understood that the number of the interfaces can be equal to the number of retractable steps after the number of the retractable steps is subsequently expanded. For example, when the step device is sold in the factory or mounted on the vehicle by a vehicle manufacturer, two retractable steps are provided, and the controller has three interfaces, one of which is used as the reserved interface. When the user or the vehicle manufacturer expands the number of the retractable steps of the step device to three according to the customer's requirements, the motor driving the added retractable step is connected with the reserved interface. The specific difference in value between the number of the interfaces and the number of the retractable steps can be set according to specific needs. In some embodiments, the number of the interfaces is set to be greater than or equal to the maximum number of the retractable steps that can be mounted to the vehicle.

Therefore, the step device of the embodiments of the present disclosure has the advantages of a low cost, a low mounting difficulty, a high integration, a wide application range, and suitability for various vehicle models.

In some embodiments, the fixed step 31 has a plurality of mounting positions, and the number of the mounting positions is greater than that of the retractable mechanisms 12, that is, the number of the mounting positions is greater than that of the retractable steps 11. Therefore, the fixed step 31 has a reserved mounting position, so that it is more convenient to add the retractable mechanism 12 and the retractable step 11.

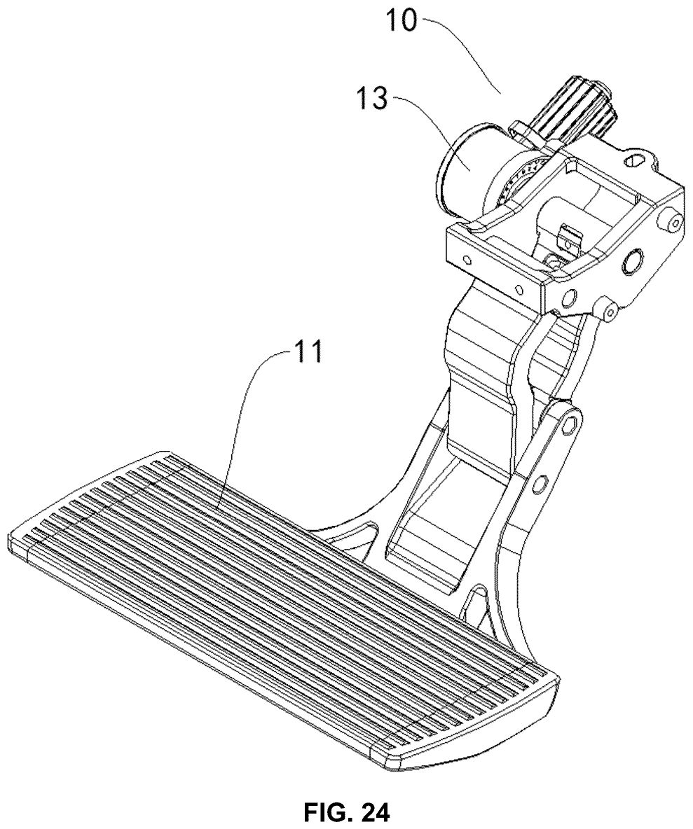

Each retractable step 11 is mounted on a corresponding retractable mechanism 12. As shown in FIG. 24, the number of the retractable mechanisms 12 may be equal to the number of the retractable steps 11. In other words, each retractable step 11 can be mounted on one retractable mechanism 12. When there are a plurality of retractable steps 11, the plurality of retractable steps 11 are mounted on a plurality of retractable mechanisms 12 in a one-to-one correspondence.

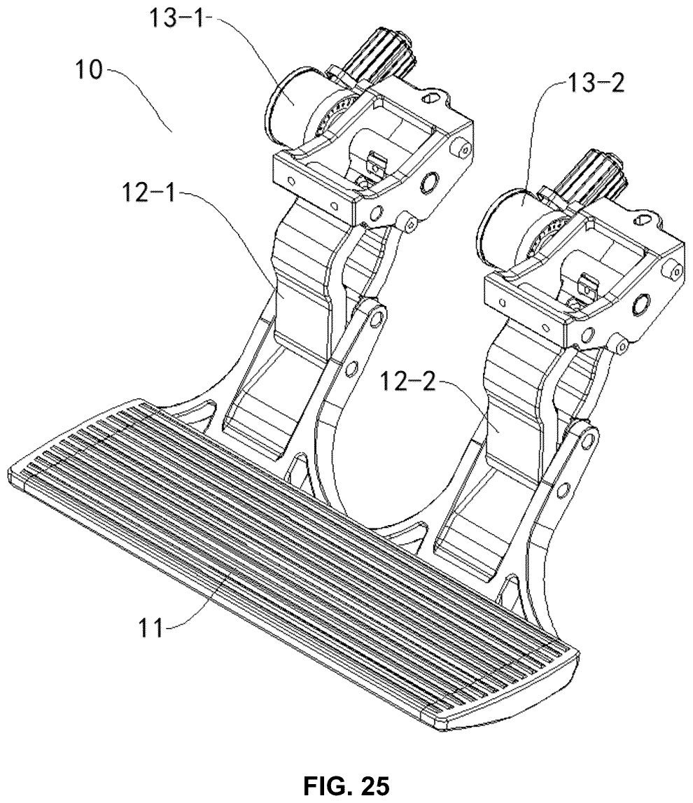

As shown in FIG. 25, the number of the retractable mechanisms 12 may be N times the number of the retractable steps 11, where N is a positive integer greater than or equal to 2. That is, if the number of the retractable steps 11 is M, the number of the retractable mechanisms 12 is N times M. Each retractable step 11 can be mounted on the N retractable mechanisms 12, that is, the N retractable mechanisms 12 drive the same retractable step 11 to move between the extended position and the retracted position. In some embodiments, as shown in FIG. 25, one retractable step 11 is mounted on two retractable mechanisms 12. In other words, one retractable step 11 is mounted on a first retractable mechanism 12-1 and a second retractable mechanism 12-2, the first retractable mechanism 12-1 is driven by a first motor 13-1 and the second retractable mechanism 12-2 is driven by a second motor 13-2.

As shown in FIGS. 24 and 25, the motors 13 have a one-to-one correspondence with the retractable mechanisms 12, and each motor 13 is connected with the corresponding retractable mechanism 12 to drive the corresponding retractable mechanism 12 to drive the corresponding retractable step 11 to move between the extended position and the retracted position. In other words, the motor 13 can drive the retractable step 11 mounted on the retractable mechanism 12 to move between the extended position and the retracted position through the corresponding retractable mechanism 12.

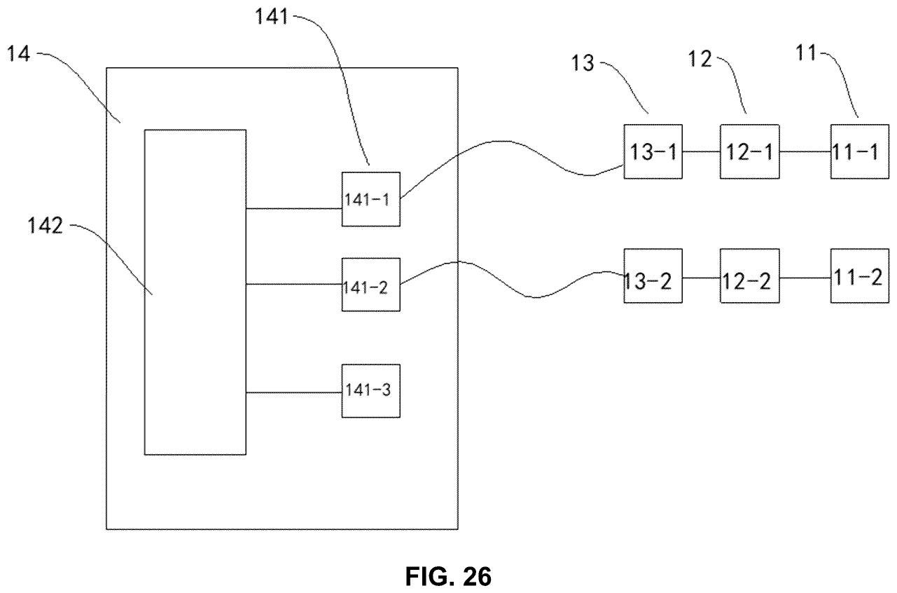

As shown in FIGS. 26-29, the controller 14 has a plurality of interfaces 141, the number of which is greater than that of the retractable steps 11, and the motor 13 driving the retractable mechanism 12 corresponding to the same retractable step 11 is connected to the same interface 141.

As shown in FIG. 24, each retractable step 11 is mounted on one retractable mechanism 12, and one motor 13 driving one retractable mechanism 12 is connected to one interface 141.

As shown in FIG. 26, the controller 14 has three interfaces, namely a first interface 141-1, a second interface 141-2 and a third interface 141-3. The step device 10 has two retractable steps, namely a first retractable step 11-1 and a second retractable step 11-2. For example, the first retractable step 11-1 may be a retractable step corresponding to two left doors of the vehicle 1, and the second retractable step 11-2 may be a retractable step corresponding to two right doors of the vehicle 1. The first retractable step 11-1 is driven by the first retractable mechanism 12-1, and the first retractable mechanism 12-1 is driven by a first motor 13-1. The second retractable step 11-2 is driven by the second retractable mechanism 12-2, and the second retractable mechanism 12-2 is driven by a second motor 13-2. The third interface 141-3 is a backup interface. For example, when the user subsequently wants to mount a retractable step at the tailgate of the vehicle 1, the user only needs to connect the motor of the retractable mechanism for driving the retractable step at the tailgate to the third interface 141-3, without replacing the controller and the control system. When the user subsequently wants to remove one retractable step, the user only needs to disconnect the motor of the retractable step from the corresponding interface and detach the retractable mechanism and the retractable step from the vehicle body 21.

Each retractable step 11 can be mounted on at least one of a plurality of retractable mechanisms 12. Even if one retractable step 11 is driven by a plurality of retractable mechanisms 12, a plurality of motors 13 driving the plurality of retractable mechanisms 12 are connected to the same interface 141. For example, as shown in FIG. 25, each retractable step 11 is mounted on two retractable mechanisms 12, and two motors 13 driving the two retractable mechanisms 12 are connected to the same interface 141.

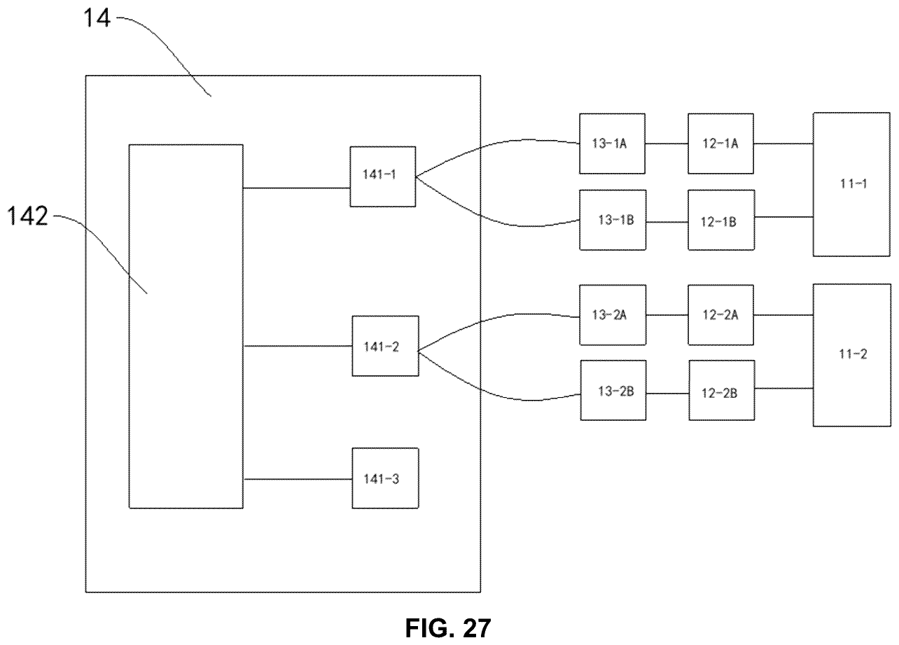

As shown in FIG. 27, the step device 10 includes a first retractable step 11-1 and a second retractable step 11-2. The controller 14 has a first interface 141-1, a second interface 141-2 and a third interface 141-3, and the third interface 141-3 is used as a backup interface. The first retractable step 11-1 is driven by a No. 1 first retractable mechanism 12-1A and a No. 2 first retractable mechanism 12-1B, the No. 1 first retractable mechanism 12-1A is driven by a No. 1 first motor 13-1A, and the No. 2 first retractable mechanism 12-1B is driven by a No. 2 first motor 13-1B. The No. 1 first motor 13-1A and the No. 2 first motor 13-1B are connected to the first interface 141-1.

Similarly, the second retractable step 11-2 is driven by a No. 1 second retractable mechanism 12-2A and a No. 2 second retractable mechanism 12-2B, the No. 1 second retractable mechanism 12-2A is driven by a No. 1 second motor 13-2A, and the No. 2 second retractable mechanism 12-2B is driven by a No. 2 second motor 13-2B. The No. 1 second motor 13-2A and the No. 2 second motor 13-2B are connected to the second interface 141-2.

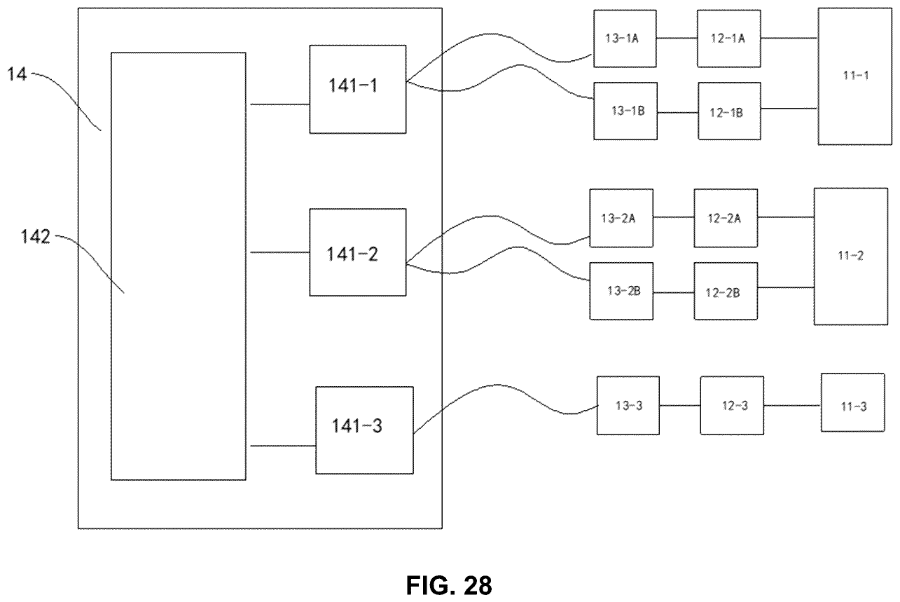

FIG. 28 shows an example embodiment that is different from the embodiment shown in FIG. 27 in that the tailgate of the vehicle is provided with a third retractable step 11-3, which is driven by a third retractable mechanism 12-3, the third retractable mechanism 12-3 is driven by a third motor 13-3, and the third motor 13-3 is connected with a third interface 141-3. If the user subsequently detaches the tailgate retractable step, it is only necessary to disconnect the third motor 13-3 from the third interface 141-3 and remove the third retractable step 11-3 and the third retractable mechanism 12-3 from the vehicle body 21.

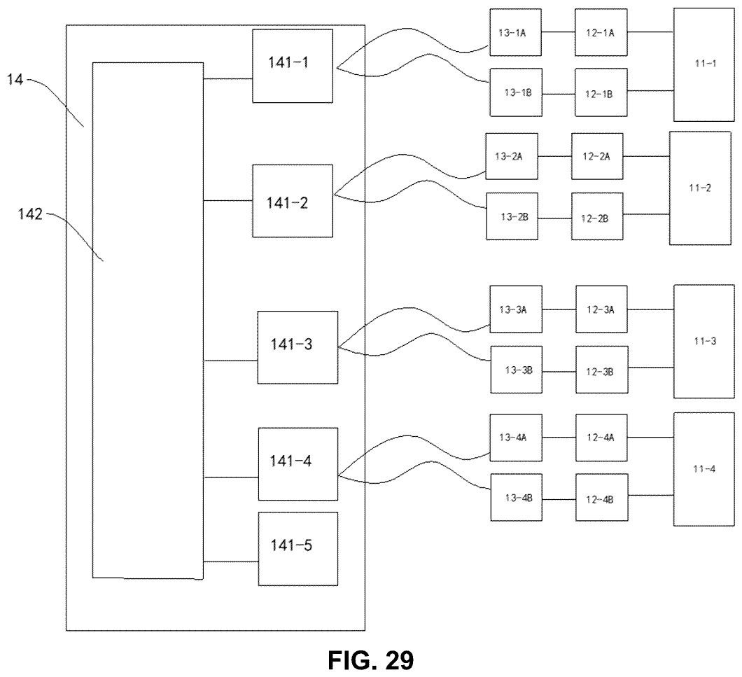

As shown in FIG. 29, there are five interfaces 141, i.e., a first interface 141-1, a second interface 141-2, a third interface 141-3, a fourth interface 141-4 and a fifth interface 141-5, and the fifth interface 141-5 is a reserved interface.

There are four retractable steps 11, i.e., a first retractable step 11-1, a second retractable step 11-2, a third retractable step 11-3 and a fourth retractable step 11-4, which correspond to a left front door 221, a left rear door 222, a right front door and a right rear door, respectively.

The first retractable step 11-1 is mounted on the No. 1 first retractable mechanism 12-1A and the No. 2 first retractable mechanism 12-1B, and the No. 1 first motor 13-1A and the No. 2 first motor 13-1B driving the No. 1 first retractable mechanism 12-1A and the No. 2 first retractable mechanism 12-1B are connected to the first interface 141-1.

The second retractable step 11-2 is mounted on the No. 1 second retractable mechanism 12-2A and the No. 2 second retractable mechanism 12-2B, and the No. 1 second motor 13-2A and the No. 2 second motor 13-2B driving the No. 1 second retractable mechanism 12-2A and the No. 2 second retractable mechanism 12-2B are connected to the second interface 141-2.

The third retractable step 11-3 is mounted on the No. 1 third retractable mechanism 12-3A and the No. 2 third retractable mechanism 12-3B, and the No. 1 third motor 13-3A and the No. 2 third motor 13-3B driving the No. 1 third retractable mechanism 12-3A and the No. 2 third retractable mechanism 12-3B are connected to the third interface 141-3.

The fourth retractable step 11-4 is mounted on the No. 1 fourth retractable mechanism 12-4A and the No. 2 fourth retractable mechanism 12-4B, and the No. 1 fourth motor 13-4A and the No. 2 fourth motor 13-4B driving the No. 1 fourth retractable mechanism 12-4A and the No. 2 fourth retractable mechanism 12-4B are connected with the fourth interface 141-4.

In some embodiments, the step device 10 further includes an extension and retraction control switch (not shown), and the controller 14 allows or prohibits the retractable step 11 from moving between the extended position and the retracted position according to a switching position of the extension and retraction control switch.

The extension and retraction control switch has a plurality of switching positions, and the controller 14 allows the retractable steps 11 whose number corresponds to the switching position to move between the extended position and the retracted position according to the switching position of the extension and retraction control switch.

For example, the vehicle 1 has a left door, a right door and a tailgate. When the extension and retraction control switch is in a 0 switching position, all the retractable steps 11 are prohibited from moving. When the extension and retraction control switch is in a 1 switching position, only the retractable step 11 corresponding to the left door is allowed to move. When the extension and retraction control switch is in a 2 switching position, only the retractable steps 11 corresponding to the left door and the right door are allowed to move. When the extension and retraction control switch is in a 3 switching position, the retractable steps 11 corresponding to the left door, the right door and the tailgate are allowed to move.

For example, the vehicle 1 has a left front door 221, a left rear door 222, a right front door, a right rear door and a tailgate. The extension and retraction control switch can have four switching positions. When the extension and retraction control switch is in a 0 switching position, all the retractable steps 11 are prohibited from moving. When the extension and retraction control switch is in a 1 switching position, only the retractable step 11 corresponding to the left front door 221 and the retractable step 11 corresponding to the left rear door 222 are allowed to move. When the extension and retraction control switch is in a 2 switching position, only the retractable step 11 corresponding to the right front door and the retractable step 11 corresponding to the right rear door are allowed to move. When the extension and retraction control switch is in a 3 switching position, the retractable steps 11 corresponding to the left front door 221, the left rear door 222, the right front door, the right rear door and the tailgate are allowed to move.

The extension and retraction control switch can also have six switching positions. When the extension and retraction control switch is in a 0 switching position, all retractable steps 11 are prohibited from moving. When the extension and retraction control switch is in a 1 switching position, only the retractable step 11 corresponding to the left front door 221 is allowed to move. When the extension and retraction control switch is in a 2 switching position, only the retractable step 11 corresponding to the left front door 221 and the retractable step 11 corresponding to the left rear door 222 are allowed to move. When the extension and retraction control switch is in a 3 switching position, only the retractable steps 11 corresponding to the left front door 221, the left rear door 222 and the right front door are allowed to move. When the extension and retraction control switch is in a 4 switching position, only the retractable steps 11 corresponding to the left front door 221, the left rear door 222, the right front door and the right rear door are allowed to move. When the extension and retraction control switch is in a 5 switching position, the retractable steps 11 corresponding to the left front door 221, the left rear door 222, the right front door, the right rear door and the tailgate are allowed to move.

Of course, the step device 10 and the vehicle 1 of the embodiments of the present disclosure are not limited to the above control modes, and the corresponding control modes can be selected according to the habits of the user.

In some embodiments, there are a plurality of retractable steps 11, and the plurality of retractable steps 11 can move between the extended position and the retracted position independently of each other. Therefore, it is only necessary to extend and retract the retractable step 11 corresponding to the door where a user enters or exits the vehicle, so that the structure of the step device 10 can be more convenient.

In some embodiments, the vehicle door includes a left door and a right door, and the step device includes a left step device mounted on the left side of the vehicle body 21 and a right step device mounted on the right side of the vehicle body 21. Either one of the retractable steps 11 of the left step device and the retractable steps 11 of the right step device can independently move between the extended position and the retracted position. Or, the retractable steps 11 of the left step device can move synchronously, and the retractable steps 11 of the right step device can move synchronously. Or, the retractable steps 11 of the left step device can move synchronously with or independently of the retractable steps 11 of the right step device.

In some embodiments, the left door includes a left front door 221 and a left rear door 222, and the fixed step 31 of the left step device is configured to include one fixed step corresponding to the left front door 221 and the left rear door 222 or includes two fixed steps having a one-to-one correspondence with the left front door 221 and the left rear door 222. The retractable step 11 of the left step device is configured to include one retractable step corresponding to the left front door 221 and the left rear door 222 or includes two retractable steps having a one-to-one correspondence with the left front door 221 and the left rear door 222.

The right door includes a right front door and a right rear door, and the fixed step 31 of the right step device is configured to include one fixed step corresponding to the right front door and the right rear door or includes two fixed steps having a one-to-one correspondence with the right front door and the right rear door. The retractable step 11 of the right step device is configured to include one retractable step corresponding to the right front door and the right rear door or includes two retractable steps having a one-to-one correspondence with the right front door and the right rear door.

The door of the vehicle 1 further includes a tailgate, the step device further includes a tail step device mounted at the tail of the vehicle body 21, and the tail step device includes one fixed step 31 and one retractable step 11 corresponding to the tailgate. Any one of the retractable steps 11 of the left step device, the right step device and the tail step device can independently move between the extended position and the retracted position. Or, the retractable steps 11 of the left step device can move synchronously, and the retractable steps 11 of the right step device can move synchronously. Or, the retractable steps 11 of the left step device, the retractable steps 11 of the right step device and the retractable steps 11 of the tail step device can move synchronously with or independently of each other.

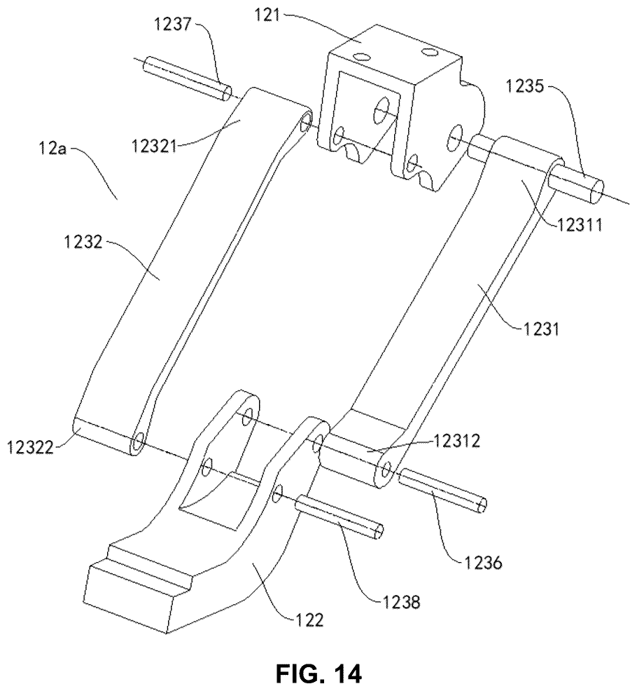

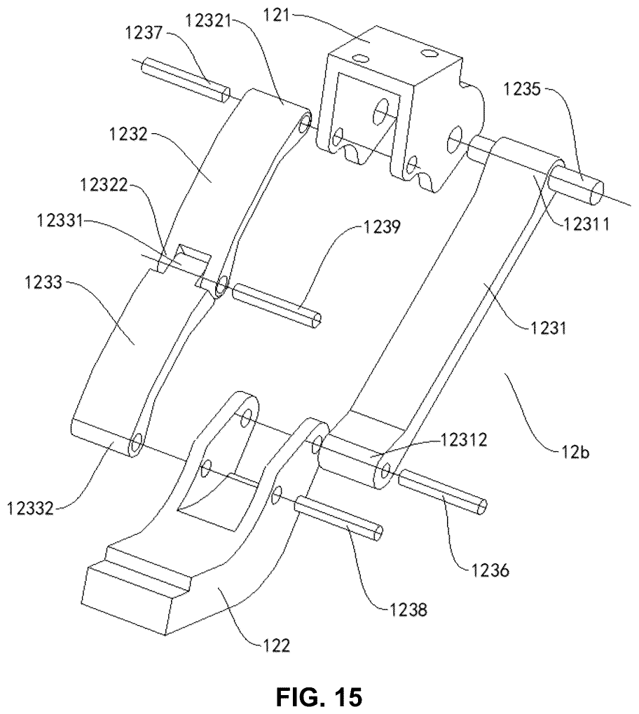

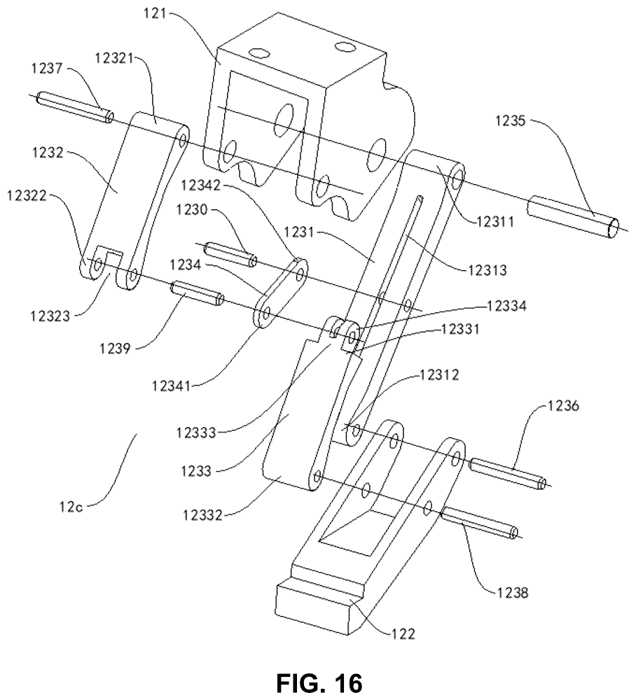

The retractable mechanism 12 is one of a four-bar linkage 12a (as shown in FIG. 14), a five-bar linkage 12b (as shown in FIG. 15) and a six-bar linkage 12c (as shown in FIG. 16). As shown in FIG. 14, the retractable mechanism 12 is a four-bar linkage 12a, and includes a mounting support seat 121, a step support seat 122, and an arm assembly connected between the mounting support seat 121 and the step support seat 122. The mounting support seat 121 is mounted on the vehicle body 21 or the fixed step, and the retractable step 11 is mounted on the step support seat 122.

The arm assembly includes a first arm 1231 and a second arm 1232. A first end 12311 of the first arm 1231 is pivotally connected to the mounting support seat 121 through a first connecting pin 1235, and a second end 12312 of the first arm 1231 is pivotally connected to the step support seat 122 through a second connecting pin 1236. The first end 12311 here refers to an upper end of the first arm 1231 as shown in FIG. 14, and the second end 12312 refers to a lower end of the first arm 1231 as shown in FIG. 14.

Similarly, a first end 12321 of the second arm 1232 is pivotally connected to the mounting support seat 121 through a third connecting pin 1237, and a second end 12322 of the second arm 1232 is pivotally connected to the step support seat 122 through a fourth connecting pin 1238. At least one of the first arm 1231 and the second arm 1232 may be connected to the motor 13. Therefore, the motor 13 drives at least one of the first arm 1231 and the second arm 1232 to pivot, and then at least one of the first arm 1231 and the second arm 1232 drives the retractable step 11 to extend and retract through the step support seat 122.

As shown in FIG. 15, the retractable mechanism 12 is a five-bar linkage 12b, and includes a mounting support seat 121, a step support seat 122, and an arm assembly connected between the mounting support seat 121 and the step support seat 122. The mounting support seat 121 is mounted on the vehicle body 21 or the fixed step, and the retractable step 11 is mounted on the step support seat 122.

The arm assembly includes a first arm 1231, a second arm 1232 and a third arm 1233. The first arm 1231 has a first end 12311 and a second end 12312. The first end 12311 here refers to an upper end of the first arm 1231 as shown in FIG. 15, and the second end 12312 refers to a lower end of the first arm 1231 as shown in FIG. 15. The first end 12311 of the first arm 1231 is pivotally connected to the mounting support seat 121 through a first connecting pin 1235, and the second end 12312 of the first arm 1231 is pivotally connected to the step support seat 122 through a second connecting pin 1236.

The second arm 1232 has a first end 12321 and a second end 12322, and the first end 12321 of the second arm 1232 is pivotally connected to the mounting support seat 121 through a third connecting pin 1237. The third arm 1233 has a first end 12331 and a second end 12332. The second end 12322 of the second arm 1232 and the first end 12331 of the third arm 1233 are pivotally connected together by a fifth connecting pin 1239, and the second end 12332 of the third arm 1233 is pivotally connected with the step support seat 122 by a fourth connecting pin 1238.

At least one of the first arm 1231 and the second arm 1232 may be connected to the motor 13. Therefore, the motor 13 drives at least one of the first arm 1231 and the second arm 1232 to pivot, and then at least one of the first arm 1231 and the second arm 1232 drives the retractable step 11 to extend and retract through the step support seat 122. By adopting the retractable mechanism 12 in the form of the five-bar linkage, the stability and accuracy of the retractable mechanism 12 in the extension and retraction process can be further improved.

As shown in FIG. 16, the retractable mechanism 12 is a six-bar linkage 12c and includes a mounting support seat 121, a step support seat 122 and an arm assembly, and the arm assembly includes a first arm 1231, a second arm 1232, a third arm 1233 and a fourth arm 1234. The mounting support seat 121 is mounted on the vehicle body 21 or the fixed step, and the retractable step 11 is mounted on the step support seat 122.

The first arm 1231 has a first end 12311 and a second end 12312. The first end 12311 here refers to an upper end of the first arm 1231 as shown in FIG. 16, and the second end 12312 refers to a lower end of the first arm 1231 as shown in FIG. 16. The first end 12311 of the first arm 1231 is pivotally connected to the mounting support seat 121 through a first connecting pin 1235, and the second end 12312 of the first arm 1231 is pivotally connected to the step support seat 122 through a second connecting pin 1236.

The second arm 1232 has a first end 12321 and a second end 12322, and the first end 12321 of the second arm 1232 is pivotally connected to the mounting support seat 121 through a third connecting pin 1237. The third arm 1233 has a first end 12331 and a second end 12332. The second end 12322 of the second arm 1232, the first end 12331 of the third arm 1233 and the first end 12341 of the fourth arm 1234 are pivotally connected together by a fifth connecting pin 1239, and the second end 12332 of the third arm 1233 is pivotally connected with the step support seat 122 through a fourth connecting pin 1238. The second end 12342 of the fourth arm 1234 is connected with the first arm 1231 through a sixth connecting pin 1230.

As shown in FIG. 16, the second end 12322 of the second arm 1232 has a U-shaped arm groove 12323, and the first end 12331 of the third arm 1233 has a projection 12333 fitted into the arm groove 12323. The projection 12333 is fitted in the arm groove 12323, and the fourth connecting pin 1239 passes through the projection 12333.

As shown in FIG. 16, the projection 12333 includes two lugs 12334 spaced apart from each other, and the first end 12341 of the fourth arm 1234 is fitted between the two lugs 12334. That is, there is an arm groove between the two spaced-apart lugs 12334, and the first end 12341 of the fourth arm 1234 is received in the arm groove.

In some embodiments, the second end 12342 of the fourth arm 1234 is connected to the middle of the first arm 1231. Therefore, the retractable mechanism 12 can be more stable in structure, uniform in stress and difficult to deform.

As shown in FIG. 16, the first arm 1231 has a first arm groove 12313, and the second end 12342 of the fourth arm 1234 is fitted in the first arm groove 12313. The second arm 1232 and the third arm 1233 are generally coaxial, and the first arm 1231 is generally parallel to the second arm 1232 and the third arm 1233.

The six-bar linkage 12c has the advantages of a more compact structure, more uniform distribution of stress, more stable movement, greater structural rigidity and strength, and a longer service life.

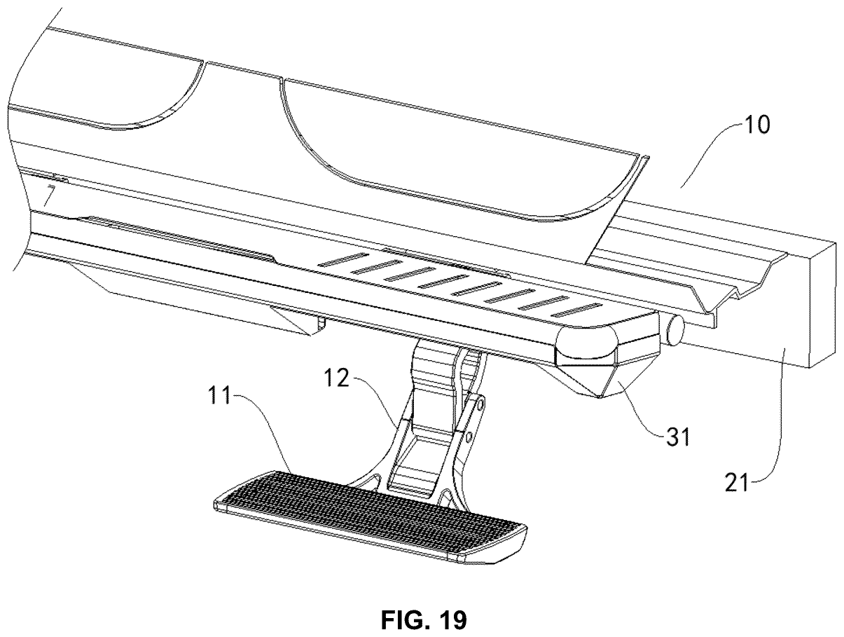

As shown in FIGS. 19-23, the retractable mechanism 12 is mounted on the fixed step 31. The retractable step 11 is mounted on the retractable mechanism 12, so that the retractable mechanism 12 drives the retractable step 11 to move between the extended position and the retracted position. That is to say, the retractable step 11 is mounted to the fixed step 31 through the retractable mechanism 12, and then indirectly fixed to the vehicle body 21 through the fixed step 31.

In some embodiments, one fixed step 31 corresponds to one retractable step 11, and each retractable step 11 is mounted on at least one of a plurality of retractable mechanisms 12. In the extended position, at least a part of the retractable step 11 extends outward from underneath the corresponding fixed step 31, so that the retractable step 11 and the corresponding fixed step 31 form two steps. In the retracted position, the retractable step 11 is retracted to a position underneath the corresponding fixed step 31.

Specifically, the vehicle 1 includes at least two fixed steps 31 and at least two retractable steps 11. A part of the fixed steps 31 are arranged on the left side of the vehicle body 21, and the rest of the fixed steps 31 are arranged on the right side of the vehicle body 21. A part of the retractable steps 11 are arranged on the left side of the vehicle body 21, each of the part of the retractable steps 11 is mounted to at least one of a plurality of retractable mechanisms 12, and the plurality of retractable mechanisms 12 are mounted to the part of the fixed steps 31. The rest of the retractable steps 11 are arranged on the right side of the vehicle body 21, each of the rest of the retractable steps 11 is mounted to at least one of a plurality of retractable mechanisms 12, and the plurality of retractable mechanisms 12 are mounted to the rest of the fixed steps 31.

In some embodiments, the tail of the vehicle body 21 is also provided with one fixed step 31 and at least one retractable step 11. Each of the at least one retractable step 11 is mounted to at least one of a plurality of retractable mechanisms 12, and the plurality of retractable mechanisms 12 are mounted to the fixed step 31 arranged at the tail of the vehicle body 21.

As shown in FIGS. 4 and 19, one fixed step 31 corresponds to a plurality of retractable steps 11, and each retractable step 11 is mounted on one retractable mechanism 12. That is, a plurality of retractable mechanisms 12 are mounted on one fixed step 31, and each retractable mechanism 12 is provided with one retractable step 11, so that the plurality of retractable steps 11 are mounted on one fixed step 31 through the plurality of retractable mechanisms 12. At the extended position, at least a part of the retractable step 11 extends outward from underneath the fixed step 31, so that the retractable step 11 and the fixed step 31 form two steps. In the retracted position, the retractable step 11 is retracted to a position underneath the fixed step 31.

Specifically, the vehicle 1 includes two fixed steps 31 and a plurality of retractable steps 11. One of the fixed steps 31 is arranged on the left side of the vehicle body 21, and the other one of the fixed steps 31 is arranged on the right side of the vehicle body 21. At least two retractable steps 11 are mounted on at least two retractable mechanisms 12 in a one-to-one correspondence, and the at least two retractable mechanisms 12 are mounted on the one of the fixed steps 31. At least two retractable steps 11 are mounted to at least two retractable mechanisms 12 in a one-to-one correspondence, and the at least two retractable mechanisms 12 are mounted to the other one of the fixed steps 31.

A plurality of retractable steps 11 corresponding to one fixed step 31 can move between the extended position and the retracted position independently of each other. That is, the plurality of retractable steps 11 mounted to the same fixed step 31 can move between the extended position and the retracted position independently of each other. Therefore, it is only necessary to extend and retract the retractable step 11 corresponding to the door where the user enters or exits the vehicle, so that the structure of the step device 10 can be more reasonable.

Specifically, the fixed step 31 arranged on the left side of the vehicle body 21 is provided with two retractable steps 11, one of which is opposite (corresponding to) the left front door 221 and the other one of which is opposite (corresponding to) the left rear door 222. When the user enters or exits the vehicle from the left front door 221, the one of the retractable steps 11 extends and retracts, and the other one of the retractable steps 11 does not move. When the user enters or exits the vehicle from the left rear door 222, the other one of the retractable steps 11 extends and retracts, and the one of the retractable steps 11 does not move.

The fixed step 31 arranged on the right side of the vehicle body 21 is provided with two retractable steps 11, one of which is opposite (corresponding to) the right front door, and the other one of which is opposite (corresponding to) the right rear door. When the user enters or exits the vehicle from the right front door, the one of the retractable steps 11 extends and retracts, while the other one of the retractable steps 11 does not move. When the user enters or exits the vehicle from the right rear door, the other one of the retractable steps 11 extends and retracts, and the one of the retractable steps 11 does not move.

In some embodiments, the tail of the vehicle body 21 is also provided with one fixed step 31 and a plurality of retractable steps 11. The plurality of retractable steps 11 are mounted to a plurality of retractable mechanisms 12 in a one-to-one correspondence, and the plurality of retractable mechanisms 12 are mounted to the fixed step 31 arranged at the tail of the vehicle body 21.

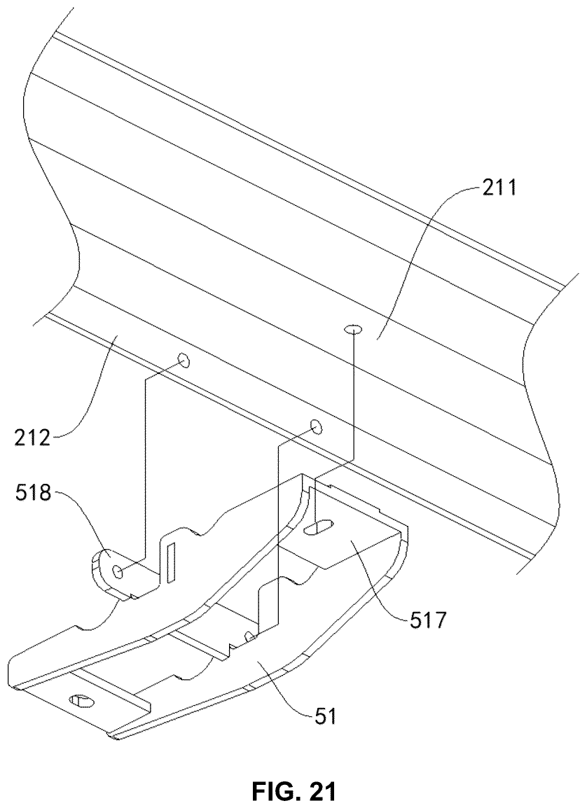

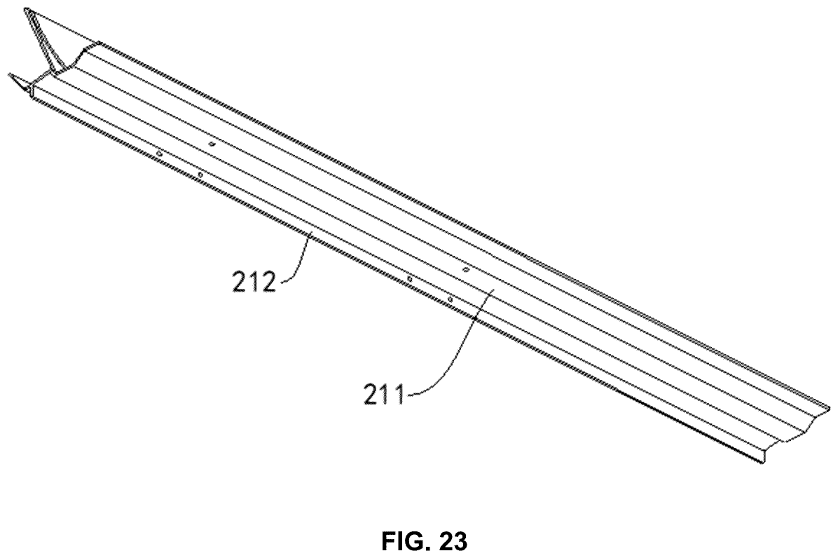

As shown in FIGS. 21 and 23, the vehicle body 21 includes a mounting bracket, which includes a second horizontal plate 211 and a second vertical plate 212, and the mounting frame 51 includes a third horizontal plate 517 and a third vertical plate 518. The third horizontal plate 517 is connected with the second horizontal plate 211 and the second vertical plate 212 is connected with the third vertical plate 518. Thus, the mounting frame 51 can be more stably mounted on the vehicle body 21.

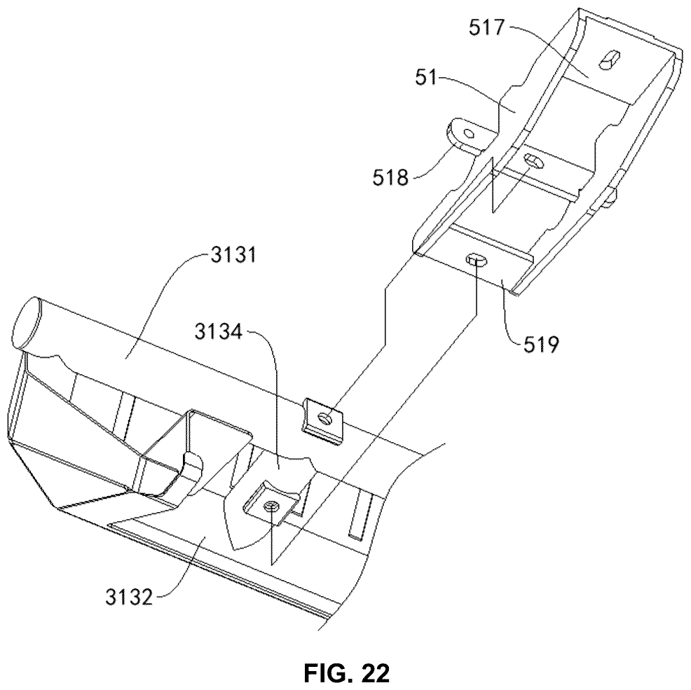

As shown in FIG. 22, the fixed step 31 includes a frame 313 and a support plate 314. The frame 313 includes an inner tube 3131, an outer tube 3132 and a plurality of reinforcing tubes 3134, and the reinforcing tubes 3134 are connected between the inner tube 3131 and the outer tube 3132. The frame 313 is connected to the support plate 316. The length direction of the inner tube 3131 coincides with the length direction of the vehicle body 21, and the length direction of the outer tube 3132 coincides with the length direction of the vehicle body 21. The plurality of reinforcing tubes 3134 are arranged at intervals along the length direction of the inner tube 3131 (the outer tube 3132), an inner end of each reinforcing tube 3134 is connected with the inner tube 3131, and an outer end of each reinforcing tube 3134 is connected with the outer tube 3132.

The mounting frame 51 further includes a fourth horizontal plate 519. The third vertical plate 518 is connected with the inner tube 3131, and the fourth horizontal plate 519 is connected with the reinforcing tube 3134. Therefore, the fixed step 31 can be more stably mounted on the mounting frame 51.

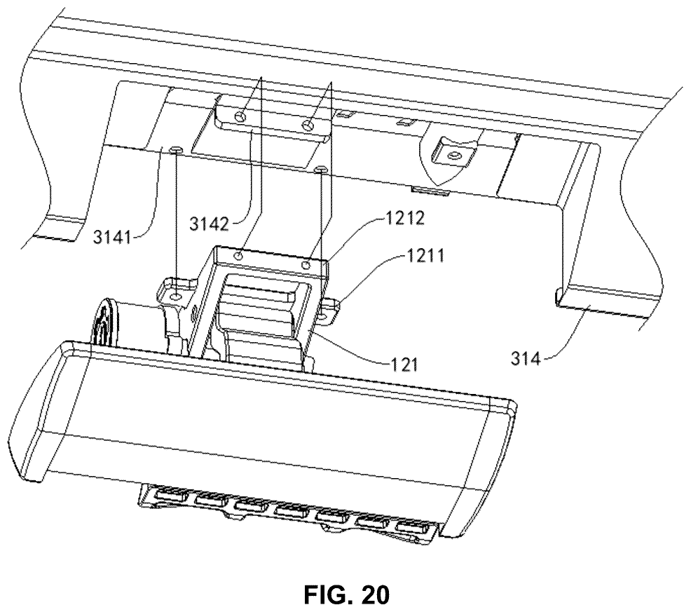

As shown in FIG. 20, the support plate 314 includes a fifth horizontal plate 3141 and a fourth vertical plate 3142, and the mounting support seat 121 of the retractable mechanism 12 includes a first horizontal plate 1211 and a first vertical plate 1212. The fifth horizontal plate 3141 is connected with the first horizontal plate 1211, and the fourth vertical plate 3142 is connected with the first vertical plate 1212. Therefore, the retractable mechanism 12 and the retractable step 11 can be more firmly mounted on the fixed step 31.

The technical features described in the above specific examples can be implemented in various configurations. Some examples of these configurations are provided below.

In some configurations, a combined step device for a vehicle includes: a mounting frame; a fixed step mounted on the mounting frame; a retractable step device including a retractable mechanism and a retractable step, the retractable mechanism being mounted to the mounting frame, and the retractable step being mounted on the retractable mechanism, so that the retractable mechanism drives the retractable step to move between an extended position and a retracted position, where in the extended position, at least a part of the retractable step extends outward beyond the fixed step from underneath the fixed step so that the retractable step and the fixed step form two steps, and in the retracted position, the retractable step retracts to a position underneath the fixed step.

In some configurations, the mounting frame includes a first side plate, a second side plate, an outer beam, an inner beam and a middle beam, where the first side plate and the second side plate are spaced apart from each other along a length direction of the fixed step, and a first end of the outer beam is connected with the first side plate, a second end of the outer beam is connected with the second side plate, a first end of the inner beam is connected with the first side plate, a second end of the inner beam is connected with the second side plate, a first end of the middle beam is connected with the first side plate, a second end of the middle beam is connected with the second side plate, the inner beam is located on an inner side of the outer beam, the middle beam is located between the inner beam and the outer beam, the fixed step is connected with the outer beam and the middle beam through a connector, and the retractable mechanism is connected with the inner beam and the outer beam through another connector.

In some configurations, the inner beam is an inner transverse plate lying horizontally, and the outer beam includes a first outer transverse plate lying horizontally and a second outer transverse plate standing vertically, an upper edge of the second outer transverse plate is connected with the first outer transverse plate, the middle beam includes a first middle transverse plate standing vertically and a second middle transverse plate standing vertically, the first middle transverse plate and the second middle transverse plate are arranged at intervals in the inner-outer direction, the fixed step is connected with the first outer transverse plate and the first middle transverse plate, the retractable mechanism is connected with the inner transverse plate and the second outer transverse plate, a lower surface of the inner transverse plate is higher than an upper surface of the first outer transverse plate, and a connection position of the fixed step with the first middle transverse plate and the second middle transverse plate is higher than the upper surface of the first outer transverse plate.

In some configurations, the retractable mechanism includes a mounting support seat, a step support seat and an arm assembly. The arm assembly is connected between the mounting support seat and the step support seat. The mounting frame has a mounting groove, and at least a part of the mounting support seat is accommodated in the mounting groove.

In some configurations, the fixed step includes a frame, a support plate and a plate bracket, the frame includes an inner tube, an outer tube, an end tube and a reinforcing tube, the support plate is mounted on the frame, the plate bracket is mounted under the frame, and the reinforcing tube is connected between the inner tube and the outer tube.

In some configurations, the fixed step has an accommodating groove, and the mounting frame is mounted in the accommodating groove. In the retracted position, the whole or part of the retractable step is accommodated in the accommodating groove.

In some configurations, at least a part of a surface of the retractable step is flush with a surface of the fixed step.

In some configurations, a bottom surface of the fixed step includes a first inclined surface portion that is inclined downward from outside to inside, and a bottom surface of the retractable step includes a first flat surface portion that is horizontal in the extended position and a second inclined surface portion that is inclined downward from outside to inside. In the retracted position, the second inclined surface portion is flush with the first inclined surface portion, and an outer side surface of the retractable step is opposite an outer side wall surface of the accommodating groove.

In some configurations, in the retracted position, a gap between the outer side surface of the retractable step and the outer side wall surface of the accommodating groove is greater than or equal to zero and less than or equal to 5 mm.

In some configurations, the step device further includes a motor, and the motor is connected with the retractable mechanism to drive the retractable mechanism to drive the retractable step to move between the extended position and the retracted position.

In some configurations, the motor is a brushless motor.

In some configurations, the combined step device for the vehicle further includes a controller, and the controller has a plurality of interfaces. The retractable step device includes at least one retractable step, each retractable step is mounted on a corresponding retractable mechanism, the number of the interfaces is greater than the number of the retractable steps, the motors have a one-to-one correspondence with the retractable mechanisms, and one motor driving one retractable mechanism corresponding to each retractable step is connected with one interface.

In some configurations, the combined step device for the vehicle further includes a controller, the controller includes a plurality of interfaces, the retractable step device includes at least one retractable step, each retractable step is mounted on at least one of a plurality of corresponding retractable mechanisms, the number of the interfaces is greater than the number of the retractable steps, the motors have a one-to-one correspondence with the retractable mechanisms, and a plurality of motors driving the plurality of retractable mechanisms corresponding to the same retractable step are connected to the same interface.

In some configurations, the combined step device for the vehicle further includes an extension and retraction control switch, and the controller allows or prohibits the retractable step from moving between the extended position and the retracted position according to a switching position of the extension and retraction control switch.

In some configurations, the extension and retraction control switch has a plurality of switching positions, and the controller allows the retractable steps whose number corresponds to the switching position to move between the extended position and the retracted position according to the switching position of the extension and retraction control switch.

In some configurations, a vehicle includes a vehicle body, a vehicle door and a step device, the step device is the combined step device for the vehicle in the above configurations, and the mounting frame of the combined step device for the vehicle is mounted on the vehicle body.

In some configurations, the whole fixed step is located on an outer side of the vehicle body or a distance between an innermost point of the fixed step and an outer side surface of the vehicle body is less than 20 mm.

In some configurations, in the retracted position, the whole retractable step is located on an outer side of the vehicle body or a distance between an innermost point of the retractable step and an outer side surface of the vehicle body is less than 30 mm.

In some configurations, the vehicle door includes a left door and a right door, and the step device includes a left step device mounted on a left side of the vehicle body and a right step device mounted on a right side of the vehicle body. Any one of the retractable steps of the left step device and the right step device can independently move between the extended position and the retracted position. Or, the retractable step of the left step device can move synchronously and the retractable step of the right step device can move synchronously. Or, the retractable step of the left step device can move synchronously with or independently of the retractable step of the right step device.

In some configurations, the left door includes a left front door and a left rear door, the fixed step of the left step device is configured to include one fixed step corresponding to the left front door and the left rear door or includes two fixed steps having a one-to-one correspondence with the left front door and the left rear door, and the retractable step of the left step device is configured to include one retractable step corresponding to the left front door and the left rear door or includes two retractable steps having a one-to-one correspondence with the left front door and the left rear door; and the right door includes a right front door and a right rear door, the fixed step of the right step device is configured to include one fixed step corresponding to the right front door and the right rear door or includes two fixed steps having a one-to-one correspondence with the right front door and the right rear door, and the retractable step of the right step device is configured to include one retractable step corresponding to the right front door and the right rear door or includes two retractable steps having a one-to-one correspondence with the right front door and the right rear door.

In some configurations, the vehicle door further includes a tailgate, and the step device further includes a tail step device mounted at a tail of the vehicle body. The tail step device includes one fixed step and one retractable step corresponding to the tailgate. Any one of the retractable steps of the left step device, the right step device and the tail step device can independently move between the extended position and the retracted position. Or, the retractable step of the left step device can move synchronously, and the retractable step of the right step device can move synchronously. Or, the retractable step of the left step device, the retractable step of the right step device and the retractable step of the tail step device can move synchronously with or independently of each other.

In some configurations, a step device includes at least one retractable step, a retractable mechanism, a motor and a controller. Each retractable step is mounted on a corresponding retractable mechanism. The motor has a one-to-one correspondence with the retractable mechanism. Each motor is connected with a corresponding retractable mechanism to drive the corresponding retractable mechanism to drive a corresponding retractable step to move between an extended position and a retracted position. The controller has a plurality of interfaces, the number of the interfaces is greater than the number of the retractable steps, and the motor driving the retractable mechanism corresponding to the same retractable step is connected with the same interface.

In some configurations, each retractable step is mounted on one retractable mechanism, and one motor driving the retractable mechanism is connected with one interface.

In some configurations, each retractable step is mounted on at least one of a plurality of retractable mechanisms, and a plurality of motors driving the plurality of retractable mechanisms are connected with the same interface.

In some configurations, a plurality of retractable steps are provided, and the plurality of retractable steps can move between the extended position and the retracted position independently of each other.

In some configurations, a vehicle includes a vehicle body, a vehicle door, and a step device mounted on the vehicle body. The step device may be the step device in the above configurations.

In some configurations, three interfaces are provided, and two retractable steps are arranged on a left side and a right side of the vehicle body, respectively. The retractable step on the left side of the vehicle body is mounted on two retractable mechanisms and two motors driving the two retractable mechanisms are connected to one interface. The retractable step on the right side of the vehicle body is mounted on another two retractable mechanisms and another two motors driving the two retractable mechanisms are connected to another interface.

In some configurations, the vehicle also includes two fixed steps, which are respectively arranged on the left side and the right side of the vehicle body to be in a one-to-one correspondence with the two retractable steps. In the extended position, at least a part of each retractable step extends outward beyond a corresponding fixed step from underneath the corresponding fixed step to form multi-stage steps, and in the retracted position, the retractable step retracts to a position underneath the corresponding fixed step.

In some configurations, four interfaces are provided, and three retractable steps are respectively arranged on the left side, the right side and the tail of the vehicle body. The retractable step on the left side of the vehicle body is mounted on two retractable mechanisms and two motors driving the two retractable mechanisms are connected to one interface. The retractable step on the right side of the vehicle body is mounted on another two retractable mechanisms and another two motors driving the two retractable mechanisms are connected to another interface. The retractable step on the tail of the vehicle body is mounted on one retractable mechanism and the motor driving the retractable mechanism is connected with a third interface.

In some configurations, the vehicle door includes a left front door, a left rear door, a right front door, a right rear door and a tailgate, five interfaces are provided, and four retractable steps respectively correspond to the left front door, the left rear door, the right front door and the right rear door.

In some configurations, a step device includes at least one retractable step, a retractable mechanism, a motor and a controller. Each retractable step is mounted on a corresponding retractable mechanism, the motor has a one-to-one correspondence with the retractable mechanism, and each motor is connected with a corresponding retractable mechanism to drive a corresponding retractable mechanism to move between an extended position and a retracted position. The controller has a plurality of interfaces, the number of the interfaces is greater than the number of the retractable steps, and the motor driving the retractable mechanism corresponding to the same retractable step is connected with the same interface.

In some configurations, each retractable step is mounted on one retractable mechanism, and one motor driving the retractable mechanism is connected to one interface.

In some configurations, each retractable step is mounted on at least one of a plurality of retractable mechanisms, and a plurality of motors driving the plurality of retractable mechanisms are connected with the same interface.

In some configurations, a vehicle includes a vehicle body, a vehicle door, and a step device mounted on the vehicle body. The step device may be the step device in the above configurations.

In some configurations, three interfaces are provided, and two retractable steps are respectively arranged on a left side and a right side of the vehicle body. The retractable step on the left side of the vehicle body is mounted on two retractable mechanisms and two motors driving the two retractable mechanisms are connected to one interface, and the retractable step on the right side of the vehicle body is mounted on another two retractable mechanisms and another two motors driving the two retractable mechanisms are connected to another interface.

In some configurations, the vehicle also includes two fixed steps, which are respectively arranged on the left side and the right side of the vehicle body to be in a one-to-one correspondence with the two retractable steps. In the extended position, at least a part of each retractable step extends outward beyond a corresponding fixed step from underneath the corresponding fixed step to form multi-stage steps, and in the retracted position, the retractable step retracts to a position underneath the corresponding fixed step.

In some configurations, four interfaces are provided, and three retractable steps are respectively arranged on the left side, the right side and the tail of the vehicle body. The retractable step on the left side of the vehicle body is mounted on two retractable mechanisms and two motors driving the two retractable mechanisms are connected to one interface. The retractable step on the right side of the vehicle body is mounted on another two retractable mechanisms and another two motors driving the two retractable mechanisms are connected to another interface. The retractable step located at the tail of the vehicle body is mounted on one retractable mechanism and the motor driving the retractable mechanism is connected with a third interface.

In some configurations, the vehicle door includes a left front door, a left rear door, a right front door, a right rear door and a tailgate, five interfaces are provided, and four retractable steps respectively correspond to the left front door, the left rear door, the right front door and the right rear door.

In the description of the present disclosure, it should be understood that the orientation or positional relationship indicated by the terms “center,” “longitudinal,” “transverse,” “length,” “width,” “thickness,” “up,” “down,” “front,” “rear,” “left,” “right,” “vertical,” “horizontal,” “bottom,” “top,” “inside,” “outside,” “clockwise,” “counterclockwise,” “axial,” “radial,” “circumferential” and the like is based on the orientation or positional relationship shown in the attached drawings, which is only for the convenience of describing the present disclosure and simplifying the description, and does not indicate or imply that the referred device or element must have a specific orientation, and be constructed and operated in a specific orientation, so it cannot be understood as a limitation of the present disclosure.

In the present disclosure, unless otherwise expressly defined, terms such as “install,” “interconnect,” “connect” and “fix” shall be understood broadly, and may be, for example, fixed connections, detachable connections, or integral connections; may also be mechanical or electrical connections or intercommunication; may also be direct connections or indirect connections via intervening media; and may also be inner communications or interactions of two elements. For those skilled in the art, the specific meaning of the above terms in the present disclosure can be understood according to the specific situations.

In the present disclosure, unless otherwise expressly defined and specified, a structure in which a first feature is “on” or “below” a second feature may include an embodiment in which the first feature is in direct contact with the second feature, or may further include an embodiment in which the first feature and the second feature are in indirect contact through middle media. Furthermore, a first feature “on,” “above” or “on top of” a second feature may include an embodiment in which the first feature is right or obliquely “on,” “above” or “on top of” the second feature, or just means that the first feature is at a height higher than that of the second feature, while a first feature “below,” “under” or “at the bottom of” a second feature may include an embodiment in which the first feature is right or obliquely “below,” “under” or “at the bottom of” the second feature, or just means that the first feature is at a height lower than that of the second feature.

In the description of the present disclosure, terms such as “an embodiment,” “some embodiments,” “an example,” “a specific example” or “some examples” mean that a particular feature, structure, material or characteristic described in connection with the embodiment or example is included in at least one embodiment or example of the present disclosure. Thus, the appearances of these terms in various places throughout this specification are not necessarily referring to the same embodiment or example of the present disclosure. Furthermore, the particular features, structures, materials or characteristics may be combined in any suitable manner in one or more embodiments or examples. In addition, without contradiction, those skilled in the art may combine and unite different embodiments or examples or features of the different embodiments or examples described in this specification.

Although the embodiments of the present disclosure have been shown and described above, it can be understood that the above embodiments are illustrative and shall not be understood as limitation to the present disclosure, and changes, modifications, alternatives and variations can be made in the above embodiments within the scope of the present disclosure by those skilled in the art.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. A step device, comprising:
a mounting frame;
a fixed step mounted on the mounting frame;
a retractable mechanism mounted to one of the mounting frame or the fixed step; and
a retractable step mounted on the retractable mechanism so that the retractable mechanism is configured to drive the retractable step to move between an extended position and a retracted position,
wherein, in the extended position, at least a part of the retractable step extends outward beyond the fixed step from underneath the fixed step so that the retractable step and the fixed step form two steps, and in the retracted position, the retractable step retracts to a position underneath the fixed step.

2. The step device according to claim 1, wherein the mounting frame comprises a first side plate, a second side plate, an outer beam, an inner beam and a middle beam, wherein the first side plate and the second side plate are spaced apart from each other along a length direction of the fixed step, a first end of the outer beam is connected with the first side plate, a second end of the outer beam is connected with the second side plate, a first end of the inner beam is connected with the first side plate, a second end of the inner beam is connected with the second side plate, a first end of the middle beam is connected with the first side plate, a second end of the middle beam is connected with the second side plate, the inner beam is located on an inner side of the outer beam, the middle beam is located between the inner beam and the outer beam, the fixed step is connected with the outer beam and the middle beam through a connector, and the retractable mechanism is connected with the inner beam and the outer beam through another connector.

3. The step device according to claim 2, wherein the inner beam is an inner transverse plate lying horizontally, and the outer beam comprises a first outer transverse plate lying horizontally and a second outer transverse plate standing vertically, an upper edge of the second outer transverse plate is connected with the first outer transverse plate, the middle beam comprises a first middle transverse plate standing vertically and a second middle transverse plate standing vertically, the first middle transverse plate and the second middle transverse plate are arranged at intervals in an inner-outer direction, the fixed step is connected with the first outer transverse plate and the first middle transverse plate, the retractable mechanism is connected with the inner transverse plate and the second outer transverse plate, a lower surface of the inner transverse plate is higher than an upper surface of the first outer transverse plate, and a connection position of the fixed step with the first middle transverse plate and the second middle transverse plate is higher than the upper surface of the first outer transverse plate.

4. The step device according to claim 1, wherein the retractable mechanism comprises a mounting support seat, a step support seat and an arm assembly, wherein the arm assembly is connected between the mounting support seat and the step support seat, the mounting frame has a mounting groove, and at least a part of the mounting support seat is accommodated in the mounting groove.

5. The step device according to claim 1, wherein the fixed step comprises a frame, a support plate and a plate bracket, wherein the frame comprises an inner tube, an outer tube, an end tube and a reinforcing tube, the support plate is mounted on the frame, the plate bracket is mounted under the frame, and the reinforcing tube is connected between the inner tube and the outer tube.

6. The step device according to claim 1, wherein the fixed step has an accommodating groove, the mounting frame is mounted in the accommodating groove, and the retractable mechanism is mounted at the accommodating groove, and in the retracted position, the whole or part of the retractable step is accommodated in the accommodating groove.

7. The step device according to claim 6, wherein in the retracted position, at least a part of a surface of the retractable step is flush with a surface of the fixed step.

8. The step device according to claim 7,
wherein a bottom surface of the fixed step comprises a first inclined surface portion that is inclined downward from outside to inside, and a bottom surface of the retractable step comprises a first flat surface portion that is horizontal in the extended position and a second inclined surface portion that is inclined downward from outside to inside, and
wherein, in the retracted position, the second inclined surface portion is flush with the first inclined surface portion, and an outer side surface of the retractable step is opposite an outer side wall surface of the accommodating groove.

9. The step device according to claim 8, wherein in the retracted position, a gap between the outer side surface of the retractable step and the outer side wall surface of the accommodating groove is greater than or equal to zero and less than or equal to 5 mm.

10. The step device according to claim 1, wherein each retractable step is mounted on a corresponding retractable mechanism, and the step device further comprises:
a motor, wherein the motor has a one-to-one correspondence with the retractable mechanism, and each motor is connected with a corresponding retractable mechanism to drive the corresponding retractable mechanism to drive a corresponding retractable step to move between the extended position and the retracted position; and
a controller having a plurality of interfaces,
wherein the step device is configured in at least one of the following manners:
each retractable step is mounted on one corresponding retractable mechanism, and the number of the interfaces is greater than the number of the retractable steps, and one motor driving one retractable mechanism corresponding to each retractable step is connected with one interface; or
each retractable step is mounted on at least one of a plurality of corresponding retractable mechanisms, the number of the interfaces is greater than the number of the retractable steps, the motor has a one-to-one correspondence with the retractable mechanism, and a plurality of motors driving a plurality of retractable mechanisms corresponding to the same retractable step are connected with the same interface.

11. The step device according to claim 10, wherein the step device further comprises an extension and retraction control switch, and the controller is configured to allow or prohibit the retractable step from moving between the extended position and the retracted position according to a switching position of the extension and retraction control switch.

12. The step device according to claim 11, wherein the extension and retraction control switch has a plurality of switching positions, and the controller is configured to allow the retractable steps whose number corresponds to the switching position to move between the extended position and the retracted position according to the switching position of the extension and retraction control switch.

13. The step device according to claim 1, wherein the step device is configured in at least one of the following manners:
one fixed step corresponds to one retractable step, and each retractable step is mounted on at least one of a plurality of retractable mechanisms; or
one fixed step corresponds to a plurality of retractable steps, each retractable step is mounted on one retractable mechanism, and the plurality of retractable steps corresponding to one fixed step are configured to move between the extended position and the retracted position independently of each other.

14. The step device according to claim 1, wherein a plurality of retractable steps are provided and configured to move between the extended position and the retracted position independently of each other.

15. A vehicle, comprising a vehicle body, a vehicle door and a step device, wherein the step device comprises:
a mounting frame;
a fixed step mounted on the mounting frame;
a retractable mechanism mounted to one of the mounting frame and the fixed step; and
a retractable step mounted on the retractable mechanism so that the retractable mechanism is configured to drive the retractable step to move between an extended position and a retracted position, wherein in the extended position, at least a part of the retractable step extends outward beyond the fixed step from underneath the fixed step so that the retractable step and the fixed step form two steps, and in the retracted position, the retractable step retracts to a position underneath the fixed step,
wherein the mounting frame of the step device is mounted on the vehicle body.

16. The vehicle according to claim 15, wherein the whole fixed step is located on an outer side of the vehicle body or a distance between an innermost point of the fixed step and an outer side surface of the vehicle body is less than 20 mm.

17. The vehicle according to claim 15, wherein in the retracted position, the whole retractable step is located on an outer side of the vehicle body or a distance between an innermost point of the retractable step and an outer side surface of the vehicle body is less than 30 mm.

18. The vehicle according to claim 15, wherein the vehicle door comprises a left door and a right door, and the step device comprises a left step device mounted on a left side of the vehicle body and a right step device mounted on a right side of the vehicle body,
wherein the step device is configured in at least one of the following manners:
any one of the retractable steps of the left step device and the right step device is configured to independently move between the extended position and the retracted position, or
the retractable step of the left step device is configured to move synchronously and the retractable step of the right step device is configured to move synchronously, or
the retractable step of the left step device is configured to move synchronously with or independently of the retractable step of the right step device.

19. The vehicle according to claim 18, wherein the vehicle is configured in at least one of the following manners:
the left door comprises a left front door and a left rear door, the fixed step of the left step device is one fixed step corresponding to the left front door and the left rear door or comprises two fixed steps having a one-to-one correspondence to the left front door and the left rear door, and the retractable step of the left step device is one retractable step corresponding to the left front door and the left rear door or comprises two retractable steps having a one-to-one correspondence with the left front door and the left rear door; and the right door comprises a right front door and a right rear door, the fixed step of the right step device is one fixed step corresponding to the right front door and the right rear door or comprises two fixed steps having a one-to-one correspondence with the right front door and the right rear door, and the retractable step of the right step device is one retractable step corresponding to the right front door and the right rear door or comprises two retractable steps having a one-to-one correspondence with the right front door and the right rear door; or
the vehicle door further comprises a tailgate, and the step device further comprises a tail step device mounted at a tail of the vehicle body, wherein the tail step device comprises one fixed step and one retractable step corresponding to the tailgate, and any one of the retractable steps of the left step device, the right step device and the tail step device is configured to independently move between the extended position and the retracted position, or the retractable step of the left step device is configured to move synchronously, and the retractable step of the right step device is configured to move synchronously, or the retractable step of the left step device, the retractable step of the right step device and the retractable step of the tail step device are configured to move synchronously with or independently of each other.

20. The vehicle according to claim 15, wherein the vehicle is configured in at least one of the following manners:
three interfaces are provided, two retractable steps are respectively arranged on a left side and a right side of the vehicle body, the retractable step on the left side of the vehicle body is mounted on two retractable mechanisms and two motors driving the two retractable mechanisms are connected with one interface, the retractable step on the right side of the vehicle body is mounted on another two retractable mechanisms and another two motors driving the two retractable mechanisms are connected with another interface, the step device further comprises two fixed steps, and the two fixed steps are respectively arranged on the left side and the right side of the vehicle body to be in a one-to-one correspondence with the two retractable steps, wherein in the extended position, at least a part of each retractable step extends outward beyond a corresponding fixed step from underneath the corresponding fixed step to form multi-stage steps, and in the retracted position, the retractable step retracts to a position underneath the corresponding fixed step; or
four interfaces are provided, three retractable steps are respectively arranged on a left side, a right side and a tail of the vehicle body, the retractable step on the left side of the vehicle body is mounted on two retractable mechanisms and two motors driving the two retractable mechanisms are connected to one interface, the retractable step on the right side of the vehicle body is mounted on another two retractable mechanisms and another two motors driving the two retractable mechanisms are connected to another interface, and the retractable step on the tail of the vehicle body is mounted on one retractable mechanism and the motor driving the retractable mechanism is connected with a third interface; or
the vehicle door comprises a left front door, a left rear door, a right front door, a right rear door and a tailgate, five interfaces are provided, and four retractable steps are provided and respectively correspond to the left front door, the left rear door, the right front door and the right rear door.
